(19) United States
(12) Patent Application Publication
(10) Pub. No.: US 2008/0082484 A1
(43) Pub. Date: Apr. 3, 2008

(54) Fast processing of an XML data stream

(75) Inventors: Amir Averbuch, Tel Aviv (IL); Shachar Harussi, Kfar Oranim (IL)

Correspondence Address: DR. MARK FRIEDMAN LTD.;C/o Bill Polkinghorn, 9003 Florin Way, Upper Marlboro, MD, 20772, US

(73) Assignee: RAMOT AT TEL-AVIV UNIVERSITY LTD.

(21) Appl. No.: 11/528,568

(22) Filed: Sep. 28, 2006

(51) Int. Cl. G06F 17/30

(52) U.S. Cl. 707/3

(57) ABSTRACT

To answer one or more queries of semistructured data, an answer automaton is constructed, based at least in part on the queries and on a schema of the data. The answer automaton is applied to the data to answer the queries. Preferably, to construct the answer automaton, a schema automaton is constructed for the schema, a query automaton is constructed for the queries, and the schema automaton and the query automaton are merged. If there are more than one query, separate query automata are constructed for the different queries and then are united to provide a joint query automaton. Preferably, all the automata are deterministic finite automata. Most preferably, all the automata are isostate automata.

### FIELD OF THE INVENTION

The present invention relates to processing of data of a semistructured language and, more particularly, to fast querying of an XML data stream.

XML has emerged as the standard for web communication and representation. XML is a textual format. The key feature that makes XML dominant is its ease of manipulation and the fact that it has become the standard for web manipulations.

XML data can be viewed as a tree. The XML tree nodes are XML tags that are called elements. The XML tree leaves are usually natural-language texts. XML format blends structural data in the tree-nodes with unstructured data in the tree leaves. This combination of structured and unstructured data serves as the basis for XML manipulation capabilities.

XML data manipulation is governed by several standards. FIG. 1 outlines these XML standards and the flow among them. FIG. 1 separates the standards into two categories:
1. XML core—standards that supply basic XML processing capabilities.
   a. XML Schema—describes the structure of the XML tree.
   b. XPath—describes the requested paths in the XML tree
2. XML manipulation—standards that supply XML with manipulation capabilities. The most common XML manipulation standards are:
   a. XSLT—describes the conversions of XML data
   b. Xquery—SQL like language to query XML data

XML functionalities and manipulation capabilities resemble those of rational databases. Currently, XML manipulation processing capabilities are significantly different from how data manipulation takes place in databases. Databases use their schema to optimize data manipulations. On the other hand, prior art XML processing ignores its schema during data manipulations.

XML message brokers have become integral modules in web services architecture. An XML message broker allows applications to exchange information by sending XML messages. The broker's task is to route the messages. The broker also performs operations such as transformations, backups, quality of service measurements and security checks.

The core technical challenge in such systems is to provide fast answers to a collection of queries on an incoming stream of XML data. We call this XML stream processing. Optimizing querying on XML streams is characterized by two problems: 1. The data that the XPath-queries operate on is constantly changing and thus it is difficult to provide efficient optimization techniques. 2. There is a huge number of queries that have to be handled and processed concurrently.

Several research projects have evaluated the construction and the performance of XPath-query processing in XML streams. The XFilter system (M. Altinel and M. Franklin, Efficient filtering of XML documents for selective dissemination, Proceedings of VLDB, 2000) constructs a separate DFA for each query. As a result, XFilter does not exploit the commonality that exists among XPath-queries. XTrie (C. Chan et al., Efficient filtering of XML documents with XPath expressions, Proceedings of ICDE, 2002) shares the processing of common sub-contexts among queries. YFilter (Y. Diao et al., Efficient and scalable filtering of XML documents, Proceedings of ICDE, 2002) detects all common prefixes, including wildcards and descendant axes. The entire workload is converted into a lazy DFA in T. J. Green et al., Processing XML streams with deterministic automata, Proceedings of ICDT, 2003. A technique for evaluating XPath-query using stack machines is described in D. Olteanu et al., An evaluation of regular path expressions with qualifiers against XML streams, Proceedings of ICDE, 2003. In this approach, a single XPath-query is translated into multiple pushdown automata that are connected by a network and need to be run in parallel and to be synchronized. Xpush (A. Kumar Gupta and Dan Suciu, Stream processing of XPath queries with predicates, Proceedings of the 2003 ACM-SIGMOD Conference, San Diego Calif., 2003, pp. 419-130) defines automaton that shares both predicates and paths.

### BACKGROUND OF THE INVENTION

There are a number of definitions and techniques that are needed to understand the description herein of the present invention. Many of these techniques can be found in standard reference texts such as Hopcroft and Ullman, Introduction to Automata Theory, Languages and Computation, Addison Wesley, 1979; Hopcroft, Motwani and Ullman, Introduction to Automata Theory, Languages and Computation, Second Edition, Pearson Education, 2001.

### Languages and Automata

A “string” (or sometimes “word”) is a finite sequence of symbols chosen from some “alphabet”. For example, 01101 is a string from the binary alphabet Σ={0,1}. The string 111 is another string chosen from this alphabet.

If Σ is an alphabet, we can express the set of all strings of a certain length from that alphabet by using an exponential notation. We define Σ^{K} to be the set of strings of length K, each of whose symbols is in Σ^{K}.

For example, note that Σ⁰ contains the “empty string” ε regardless of what alphabet Σ is. That is, ε is the only string whose length is 0.

If Σ={0,1}, then Σ¹={0,1}, Σ²={010,10,11}, Σ³={000,001,010,011,100,101,110,111}, etc.

The set of all strings over an alphabet Σ is conventionally denoted by Σ*. For instance, {0,1}*={ε, 0, 1,00,01,10, 11,000, . . . }. Put another way, Σ*=Σ⁰∪Σ¹∪Σ²∪Σ³∪ . . .

A set of strings, all of which are chosen from some Σ*, where Σ is a particular alphabet, is called a “language”. If Σ is an alphabet, and L⊂Σ*, then L is a language over Σ. Common languages can be viewed as sets of strings. An example is English, where the collection of legal English words is a set of strings over the alphabet that consists of all the letters. Another example is the set of strings of 0's and 1's with an equal number of each: L={ε,01,10,0011,0101,1001, . . . }.

An “automaton” is a model that is designed to decide whether a given input string is a member of some particular language. More precisely, if Σ is an alphabet and L is a language over Σ*, then given a string w in Σ*, the automaton decides whether or not w is in L. We say that the automaton “accepts” this language L. That an automaton “accepts” a language means that the automaton decides whether a given string is a member of the language. If the automaton decides that the string is a member of the language then the automaton has “accepted” the string. If the automaton decides that the string is not a member of the language then the automaton has “rejected” the string.

There are several types of automata. Each type of automaton accepts a different class of language. The present invention uses a class of languages known as “regular languages”. These languages are exactly the ones that are accepted by finite automata. A “finite automaton” (denoted hereinafter by FA) has a set of a finite number of states, and its “control” moves from state to state in response to external “inputs: Formally, a finite automaton consists of:
1. A finite set of “states”, denoted by Q.
2. A finite set of “input symbols”, denoted by Σ.
3. A “transition function”, or “control” that takes as arguments a state from Q and an input symbol from Σ and returns a state. The transition function commonly is denoted by δ. The δ function operates as follows: δ(q,a)=q where q,q∈Q, a∈Σ.
4. A “start state”, which is one of the states in Q, denoted by q₀.
5. A set of “final or accepting states”, denoted by F. The set F is a subset of Q.

The most succinct representation of a finite automaton is a listing of these five components. We often talk about a FAA in five-tuple notation: A={Q,Σ,δ, q₀, F}.

One of the crucial distinctions among classes of finite automata is whether the transition function δ is “deterministic”, meaning that the automaton cannot be in more than one state at any time, or “nondeterministic”, meaning that the automaton may be in several states at once. A deterministic finite automaton is denoted hereinafter by “DFA”. A non-deterministic finite automaton is denoted hereinafter by “NDFA”.

Formally, the difference between a DFA and a NDFA is in the transition function δ. A DFA's transition function is limited to a single transition from a state q that accepts a symbol a. NDFA transition function can include more than one transition (q, a) and therefore may be in several states at the same time. The class of languages accepted by DFAs is the same as the one accepted by NDFAs: the “regular languages”.

Regular languages are closed under three Boolean operations: union, intersection and completion:
1. Union: Let L and M be languages over an alphabet Σ. Then L∪M is the language that contains all strings that are in either or both of L and M.
2. Let L and M be languages over an alphabet Σ. Then L∩M is the language that contains all strings that are in both L and M.
3. Let L be a language over an alphabet Σ. Then L̅ is the language that contains all strings in Σ* the are not in L.
If A₁ is the FA that accepts L and A₂ is the FA that accepts M, then from A₁ and A₂ a new FA that is called A can be constructed that accepts either L∪M or L∩M or L̅. Specifically, let A₁={Q₁,Σ, δ₁,q₀_{₁},F₁} and A₂={Q₂,Σ,δ₂,q₀_{₂}, F₂} be two FA. The intersection L∩M between them, denoted by A=A₁∩A₂, is defined as A={Q,Σ,δ,q₀,F} where Q=Q₁×Q₂, δ((q₁,q₂),a)=δ₁(q₁,a)×δ₂(q₂,a), q₁∈Q₁,q₂∈Q₂, q₀=q₀_{₁}×q₀_{₂},F=F₁×F₂.

In the present invention we use a special type of automaton denoted hereinafter by IA. This type of automaton assumes that every incoming transition that accepts the same symbol enters the same state. Incoming transitions of a single state can accept more than one symbol. A IA accepts a subclass of regular languages that is denoted hereinafter by IL. In the appended claims, a IA is referred to as an “isostate automaton”.

A “finite state machine” (denoted herein by “FSM”) is a graphical representation of a finite automaton. FIG. 2 is an example of a FSM that accepts the language L={w|w has both an even number of 0's and an even number of 1's}.

The graph representation of the finite-automaton model of FIG. 2 has the following formal description:
1. The states Q are represented by circles. In FIG. 2, Q={q₀,q₁,q₂,q₃}
2. The input symbols Σ are labeled on the arcs. In FIG. 2, Σ={0,1}.

3. The arcs represent transitions of the transition function δ. In FIG. 2, δ(q₀,0)=q₂,δ(q₀,1)=q₁, . . . δ(q₂,0)=q₀,δ(q₂,1)=q₃.
4. The start state q₀ can optionally be indicated by an arrow leading to that state labeled by the word Start. Herein, the start state is graphically denoted by two circles where the inner circle is shaded in black.
5. The final states F are denoted by inner circles. In FIG. 2, F={q₀}.

A DFA processes an input string as follows. Suppose a₁a₂ . . . aₙ is an input string. We start out with the DFA in its start state q₀. We consult the transition function δ, say δ(q₀,a₁)=q₁ to find the state that the DFA enters after processing the first input symbol a₁. We process the next input symbol a₂ by evaluating δ(q₁,a₁), let us suppose this state is q₂. We continue in this manner, finding states q₁q₂ . . . qₙ such that δ(qᵢ₋₁,aᵢ)=qᵢ for each step i. If qₙ is a member of F, qₙ∈F, then the input string a₁a₂ . . . aₙ is accepted (belongs to the language), and if not then the input string is rejected.

A “transition-sequence” is a sequence of transitions δ₁, . . . , δₙ that satisfies δᵢ=(qᵢsᵢ)→qᵢ₊₁,i=0, . . . ,n−1 where q₀ is the start symbol and qₙ∈F. A transition-sequence accepts the word w∈L, W=s₀ . . . sₙ₋₁ where L is accepted by the corresponding DFA.

### Regular Expressions

A “Regular Expression” is an algebraic description of a language. Regular expressions, denoted hereinafter by “RE”, define exactly the same languages that finite automata accept, the regular languages. However, regular expressions offer a declarative way to express the strings we want to accept.

RE construction starts with input symbols that are elementary expressions. Each input symbol is an expression. We construct more complex expressions by applying a set of operations to the elementary expressions and to previously constructed expressions. Each operator is marked with a special symbol. In the following, we assume that we have two regular expressions R_{L} and R_{M} that express the languages L and M, respectively. The three operations are:
1. The “union” of two regular expressions R_{L} and R_{M}, denoted by R_{L}+R_{M}, is the set of strings that are in either L or in M or in both. For example, if L={001,10,111} and M={e, 001}, then L+M={e, 10,001, 111}.
2. The “concatenation” of the regular expressions R_{L} and R_{M} is the set of strings that can be formed by taking any string in L and concatenating the string with any string in M. For example, if L={001, 10,111} and M={ε, 001}, then LM, is {001, 10, 111, 001001, 10001, 111001}. The first three strings in LM are the strings in L concatenated with ε.

Since ε is the identity for concatenation, the resulting strings are the same as the strings of L. However, the last three strings in LM are formed by taking each string in L and concatenating the string with the second string in M, which is 001. For instance, 10 from L concatenated with 001 from M gives us 10001 for the corresponding string of LM.
3. The closure of a language L, denoted by R_{L}*, represents the set of all strings that can be formed by taking any number of strings from L, possibly with repetitions (i.e., the same string may be selected more than once) and concatenating them all. For instance, if L={0, 1}, then L* is all strings of 0's and 1's. If L={0, 11}, then L* consists of those strings of 0's and 1's such that the 1's come in pairs, e.g., 011, 11110, and ε, but not 01011 or 101.

For a simple example, the regular expression “01*+10*” denotes the language consisting of all the strings that are either a single 0 followed by any number of 1's or a single 1 followed by any number of 0's.

### Labeled Graphs and Languages

A “graph” is a set of objects called “vertices” or “nodes” joined by links called “edges”. Typically, a graph is depicted as a set of circles (nodes) joined by lines (the edges).

A “directed graph” G is an ordered pair G=(V, E) with

A set of vertices or nodes denoted by V
A set of ordered pairs of nodes, denoted by E, called “directed edges”.
An edge e=(x, y) is considered to be directed from x to y. y is called the “head” of the edge. x is called the “tail” of the edge

A “labeled graph” is a graph with labels assigned to its nodes or edges. These assignments do not have to be unique, i.e. different nodes or edges can have the same label. Mathematically, a labeled graph can be defined as follows:

Given an alphabet Σ_{V}, a node-labeled-graph is a triple G=(V, E, lᵥ) where
V is a finite set of nodes
E is a finite set of edges
lᵥ:V→Σᵥ is a function that describes the labeling of the nodes.

Given an alphabet Σ_{E}, an edge-labeled-graph is a graph G=(V,E) where
V is a finite set of nodes
E⊂V×Σ_{E}×V is a ternary relation describing the edges (including the labels of the edges)

For example, the FSM of FIG. 2 is a directed graph in which both the nodes and the edges are labeled. Σ_{E}=Σ={0,1} and Σᵥ=Q={q₀,q₀,q₂,q₃}

A “path” in a graph is a sequence of vertices such that from each vertex there is an edge to a successor vertex. The first vertex in a path is called the “start vertex” and the last vertex in the path is called the “end vertex”. The other vertices in the path are “internal vertices”.

A “tree” is a graph in which any two vertices are connected by exactly one path. A tree is called a “rooted tree” if one vertex has been designated to be the root, in which case the edges have a natural orientation, away from the root. In a rooted tree, the root has a path to all the rest of the nodes.

A node-labeled-graph G=(V,E,lᵥ) and a vertex v′∈V define a “node language” L_{v′}={w| there is a path p such that v′ is the start vertex of p and w=lᵥ(p)}. A node labeled rooted tree and its root define the “root language” of all paths in the tree. This language is denoted herein as Lᵣₒₒₜ.

### Semistructured Data

A “data model” is a concrete representation of entities, properties, relationships and operations defined in a manner that allows actual instances of those entities to be managed, manipulated, stored, operated upon and verified. A data model is also called a “schema”.

“Semistructured data” has many definitions. The definition used herein is in the definition presented by Peter Buneman in Semistructured data tutorial, Proceedings of A CM Symposium on Principles of Database Systems (PODS) (1997): Semistructured data is:
1. self-describing—the data contains its model or a reference to its model, if such a model exists.
2. irregular.
3. modeled as a labeled graph.

Semistructured data models represent naturally Web data where the data is mixed with free text, and the boundary between data and text is sometimes blurred.

XML data is semistructured data. XML data is modeled as a node labeled tree. An alphabet Σᵥ of an instance of XML data, is a finite set of symbols that represents tag-strings. The tag strings are called elements. Lᵣₒₒₜ of an instance of XML data contains all the sequences of elements of nodes in the path from the root.

A “query” is a statement of information needs. A “query language” is a format in which a query is written. A “semistructured query”, is a query expressed in a semistructured query formats such as XPath, Xquery, UnQL (P. Buneman et al., UnQL: A Query Language and Algebra for Semistructured Data Based on Structural Recursion, VLDB Journal 9, 2000) and XML-QL (A. Deutsch et al., XML-QL: A Query Language for XML, Computer Networks, vol. 31 pp. 11-16 (1999)).

A semistructured query states a pattern of semistructured model entities that is called a “context”. The context is “matched” to the semistructured data in order to “answer” the query. The query is answered when labels on the path in the data graph compose a word that matches the sought after context pattern.

An “XPath-query” defines the context of elements to be matched in XML data. The context is expressed as a sequence of “XPath-expressions”. An XPath-expression contains the following information:
1. A “path operator” that can be
   a. The ‘/’ character matches the children of the current node
   b. The string ‘//’ matches all descendant of the current node
2. The element that matches nodes that are labeled by this element

An “unbound XPath-expression” is an expression that includes the ‘//’ path operator.

“XPath-query” is defined herein without attributes in order to simplify the algorithmic description. However, extending the definition to attributes is straightforward.

A RE can be constructed from a semistructured query. The following is an example that demonstrates such a construction. A RE is constructed from an XPath-query as follows:
1. The ‘/’ character is replaced by an empty string (the concatenation operator).
2. The ‘//’ string is replaced by Σ*ᵥ.
3. The element string is replaced by the symbol from Σᵥ that represents the element string.

The constructed RE defines the language L_{query}. For example, the RE ‘(a+b)*ab’ is constructed from the XPath-query ‘//a/b’ where Σᵥ={a,b}. This RE defines all the paths of the XML data that have any combination of a and b elements followed by an element a with a child b. A DFA that accepts a language L_{query} is denoted herein after by DFA_{query}. A transition-sequence matches the context of a query if the transition sequence accepts the word w, w∈=L_{query}.

A semistructured data schema defines the labeled graph structure of the corresponding semistructured data. An XML schema defines the tree structure of corresponding XML data. An XML schema may be used to verify the integrity of the content.

We define L_{schema} as the language of all possible paths on a labeled graph allowed by the corresponding semistructured schema. For any XML data, always Lᵣₒₒₜ⊂L_{schema}. The language of all possible query answers on data with a given schema is denoted hereinafter by L_{answer}. Formally, we define this operation to be L_{answer}=L_{schema}∩L_{query}.

There are many XML formats that are used to define an XML schema. Examples of such formats include DTD, XML Schema, etc. A DFA that accepts L_{schema} can be constructed from these formats. Such a DFA is denoted herein as DFA_{schema}. The dictionary pushdown transcoder (DPDT), which is described by Averbuch et al. in US Patent Application Publication No. 2006/0117307 (henceforth, “Averbuch et al. '307”), is an automaton that accepts XML Scheme language. A DFA_{schema} can be constructed from a DPDT automaton.

Averbuch et al. '307 is incorporated by reference for all purposes as if fully set forth herein

An XPath-query is “valid” for a given schema if L_{query}∩L_{schema}≠Ø. Otherwise, the XPath-query is “invalid”.

### SUMMARY OF THE INVENTION

The current approaches to XML stream processing use different types of automata to match an XPath-query context in the XML stream. We follow these approaches and use a DFA to match the query contexts. Unlike previous techniques, our DFA is driven from the schema of the processed XML document.

Previous approaches have not taken into considerations the schema of the XML data. As a result, the automata they use do not fit because these automata process contexts that do not occur due to the XML Schema restrictions. These automata tend to have a large number of states. A partial suggested solution, Xpath of Gupta and Suciu cited above, (is to update the automata transitions during XML document processing. This solution is inefficient and computational expensive.

Therefore according to the present invention there is provided a method of answering a query of semistructured data, including the steps of: (a) constructing an answer automaton, based at least in part on the query and on a schema of the data; and (b) applying the answer automaton to the data to answer the query.

Furthermore, according to the present invention there is provided a method of answering a plurality of queries of semistructured data, including the steps of: (a) constructing an answer automaton, based at least in part on the queries and on a schema of the data; and (b) applying the answer automaton to the data to answer the queries.

Furthermore, according to the present invention there is provided a device for processing semistructured data transmitted on a network, including: (a) a network interface for receiving the data from the network; (b) a memory for storing executable code for answering at least one query of the data, the executable code including: (i) executable code for constructing an answer automaton, based at least in part on the at least one query and on a schema of the data, and (ii) executable code for applying the answer automaton to the data to answer the at least one query; and (c) a processor for executing the executable code.

Furthermore, according to the present invention there is provided a computer-readable storage medium having computer-readable code embodied on the computer-readable storage medium, the computer-readable code for answering at least one query of semistructured data, the computer-readable code including: (a) program code for constructing an answer automaton based at least in part on a schema of the data and on the at least one query; and (b) program code for applying the answer automaton to the data to answer the at least one query.

Furthermore, according to the present invention there is provided a system for answering a query of semistructured data, including: (a) a schema automaton constructor for constructing a schema automaton for a schema of the data; (b) a query automaton constructor for constructing a query automaton for the query; (c) an answer automaton constructor for merging the schema automaton and the query automaton to provide an answer automaton; and (d) an answer automaton engine for applying the answer automaton to the data to answer the query.

Furthermore, according to the present invention there is provided a system for answering a plurality of queries of semistructured data, including: (a) a schema automaton constructor for constructing a schema automaton for a schema of the data; (b) a query automaton constructor for constructing respective query automata for the queries; (c) a query automaton merge engine for merging the query automata to provide a joint query automaton; (d) an answer automaton constructor for merging the schema automaton and the joint query automaton to provide an answer automaton; and (e) an answer automaton engine for applying the answer automaton to the data to answer the queries.

Furthermore, according to the present invention there is provided a method of answering a query of semistructured data, including the steps of: (a) constructing an answer automaton, based at least in part on the query, the constructing including removing redundant symbols from the answer automaton; and (b) applying the answer automaton to the data to answer the query.

Furthermore, according to the present invention there is provided a device for processing semistructured data, including: (a) a memory for storing executable code for answering a query of the data, the executable code including: (i) executable code for constructing an answer automaton, based at least in part on the query, the constructing including removing redundant symbols from the answer automaton, and (ii) executable code for applying the answer automaton to the data to answer the query; and (b) a processor for executing the executable code.

Furthermore, according to the present invention there is provided a computer-readable storage medium having computer-readable code embodied on the computer-readable storage medium, the computer-readable code for answering a query of semistructured data, the computer-readable code including: (a) program code for constructing an answer automaton, based at least in part on the query, the constructing including removing redundant symbols from the answer automaton; and (b) program code for applying the answer automaton to the data to answer the query.

Furthermore, according to the present invention there is provided a system for answering a query of semistructured data, including: (a) an answer automaton constructor for constructing an answer automaton, based at least in part on the query, the constructing including removing redundant symbols from the answer automaton; and (b) an answer automaton engine for applying the answer automaton to the data to answer the query.

Furthermore, according to the present invention there is provided a method of answering a query of semistructured data, including the steps of: (a) constructing, for the query, a finite query automaton that accepts an alphabet; (b) mapping the alphabet into a set of transition indices of the finite query automaton, thereby transforming the finite query automaton into an isostate query automaton; (c) transforming the isostate query automaton into an answer automaton; and (d) applying the answer automaton to the data to answer the query.

Furthermore, according to the present invention there is provided a device for processing semistructured data, including: (a) a memory for storing executable code for answering a query of the data, the executable code including: (i) executable code for constructing, for the query, a finite query automaton that accepts an alphabet, (ii) executable code for mapping the alphabet into a set of transition indices of the finite query automaton, thereby transforming the finite query automaton into an isostate query automaton, (iii) executable code for transforming the isostate query automaton into an answer automaton, and (iv) executable code for applying the answer automaton to the data to answer the query; and (b) a processor for executing the executable code.

Furthermore, according to the present invention there is provided a computer-readable storage medium having computer-readable code embodied on the computer-readable storage medium, the computer-readable code for answering a query of semistructured data, the computer-readable code including: (a) program code for constructing, for the query, a finite query automaton that accepts an alphabet; (b) program code for mapping the alphabet into a set of transition indices of the finite query automaton, thereby transforming the finite query automaton into an isostate query automaton; (c) program code for transforming the isostate query automaton into an answer automaton; and (d) program code for applying the answer automaton to the data to answer the query.

Furthermore, according to the present invention there is provided a system for answering a query of semistructured data, including: (a) a query automaton constructor for: (i) constructing, for the query, a finite query automaton that accepts an alphabet, and (ii) mapping the alphabet into a set of transition indices of the finite query automaton, thereby transforming the finite query automaton into an isostate query automaton; (b) an answer automaton constructor for transforming the isostate query automaton into an answer automaton; and (c) an answer automaton engine for applying the answer automaton to the data to answer the query.

An elementary method of the present invention, for answering a query of semistructured data such as XML data, includes two steps. In the first step, an answer automaton (e.g. DFA_{minXPath} of FIG. 3 below) is constructed, based at least in part on the query and on a schema of the data. In the second step, the answer automaton is applied to the data to answer the query. Preferably, the answer automaton is a deterministic finite automaton. Most preferably, the answer automaton is a isostate automaton.

Preferably, the answer automaton is constructed by constructing a schema automaton (e.g., DFA_{Schema} of FIG. 3 below) for the schema, constructing a query automaton (e.g., DFA_{query} of FIG. 3 below) for the query, and merging the schema automaton and the query automaton to provide the answer automaton. Most preferably, the schema automaton and the query automaton are merged by forming an intersection of the schema automaton and the query automaton. More preferably, the answer automaton, the schema automaton and the query automaton all are deterministic finite automata. Most preferably, the answer automaton, the schema automaton and the query automaton all are isostate automata. The schema automaton first is constructed as a finite automaton that accepts an alphabet. Then, the alphabet is mapped into a set of transition indices that accept the alphabet, thereby transforming the automaton into an isostate automaton.

Optionally, the schema is built from the data.

Preferably, applying the answer automaton to the data includes parsing the data, using the answer automaton, to provide a matched context. Most preferably, applying the answer automaton to the data also includes calculating a Boolean expression, that is included in the query, on a textual value of the matched context. Also most preferably, the construction of the answer automaton includes using a parser generator (e.g., XML Parser Generator (2) of FIG. 20 below) to construct a schema automaton for the schema. The parser generator also produces parser tables (e.g., Parser Tables (e) of FIG. 20 below). The parsing of the data includes using the parser tables to parse the data, thereby producing parser symbols (e.g., Parser Symbols (j) of FIG. 20 below), followed by parsing the parser symbols, using the answer automaton.

Preferably, constructing the answer automaton includes removing redundant symbols from the answer automaton.

Preferably, the method also includes the step of constructing a parsing table for the data, based on the schema, and the step of using the parser table to validate the data, prior to applying the answer automaton to the data to answer the query. For example, the data can be validated as taught in Averbuch et al. '307.

Another elementary method of the present invention, for answering two or more queries of semistructured data such as XML data, includes two steps. In the first step, an answer automation (e.g., DFAₘᵢₙ_{_{XPath}}^{C}^{^{k}} of FIG. 20 below) is constructed, based at least in part on the queries and on a schema of the data. In the second step, the answer automaton is applied to the data to answer the queries.

Preferably, the answer automaton is constructed by constructing a schema automaton (e.g., DFA_{schema} of FIG. 20 below) for the schema, constructing a joint query automaton (e.g., DFA_{query}^{C}^{^{k}} of FIG. 20 below) for the queries, and merging the schema automaton and the joint query automata to provide the answer automaton. Most preferably, the joint query automaton is constructed by constructing a respective query automaton (e.g., DFA_{query} of FIG. 20 below) for each query and then uniting the query automata to provide the joint query automaton.

The scope of the present invention also includes a device for processing semistructured data, using the methods of the present invention, and a computer-readable storage medium having embedded thereon program code for implementing the methods of the present invention. The device includes a memory for storing executable code for implementing the methods of the present invention and a processor for executing the executable code. Preferably, the device also includes a network interface for receiving the data from a network.

The scope of the present invention also includes a system for answering a query of semistructured data and a system for answering a plurality of queries of semistructured data.

A basic system for answering a query of semistructured data includes a schema automaton constructor, a query automaton constructor, an answer automaton constructor and an answer automaton engine. The schema automaton constructor constructs a schema automaton for a schema of the data. The query automaton constructor constructs a query automaton for the query. The answer automaton constructor merges the schema automaton and the query automaton to provide an answer automaton. The answer automaton engine applies the answer automaton to the data to answer the query.

Preferably, the system also includes a schema constructor for constructing the schema from the data.

Preferably, the schema automaton constructor includes a parser generator for generating (a) parse table(s) for the data, and the apparatus also includes a parser that uses the parse table(s) to validate the data.

Preferably, the answer automaton parses the data to provide a matched context, and the apparatus also includes a text matcher for calculating a Boolean expression, that is included in the query, on a textual value of the matched context.

In one preferred embodiment of the system, the schema automaton constructor, the query automaton constructor, the answer automaton constructor and the answer automaton engine are implemented in a single common device. In another preferred embodiment of the system, the schema automaton constructor, the query automaton constructor, the answer automaton constructor and the answer automaton engine are implemented in respective members of a plurality of devices that are operationally coupled by a network. For example, FIG. 24 below shows schema automaton constructor 308, query automaton constructor 310 and answer automaton constructor 314 in offline device 230, and answer automaton engine 420 in online device 240.

A system of the present invention, for answering a plurality of queries of semistructured data, includes a schema automaton constructor, a query automaton constructor, a query automaton unite engine, an answer automaton constructor and an answer automaton engine. The schema automaton constructor constructs a schema automaton for a schema of the data. The query automaton constructor constructs respective query automata for the queries. The query automaton unite engine unites the query automata to provide a joint query automaton. The answer automaton constructor merges the schema automaton and the joint query automaton to provide an answer automaton. The answer automaton engine applies the answer automaton to the data to answer the queries.

In one preferred embodiment of the system, the schema automaton constructor, the query automaton constructor, the query automaton unite engine, the answer automaton constructor and the answer automaton engine are implemented in a single common device. In another preferred embodiment of the system, the schema automaton constructor, the query automaton constructor, the query automaton unite engine, the answer automaton constructor and the answer automaton engine are implemented in respective members of a plurality of devices that are operationally coupled by a network. For example, FIG. 24 below shows schema automaton constructor 308, query automaton constructor 310, query automaton unite engine 316 and answer automaton constructor 314 in offline device 230, and answer automaton engine 420 in online device 240.

Another method of the present invention, for answering a query of semistructured data, includes two steps. In the first step, an answer automaton is constructed, based at least in part on the query. Constructing the answer automaton includes removing redundant symbols from the answer automaton. In the second step, the answer automaton is applied to the data to answer the query. In the preferred embodiments described below, the data are streaming data on a network. It will be clear to those skilled in the art that the method also may be used to answer a query of data in a database, e.g. data in a relational database.

A related device for processing semistructured data includes a memory in which is stored executable code for implementing the method to answer a query of the data and a processor for executing the code. Preferably, the device also includes a network interface for receiving the data from a network.

The scope of the present invention also includes a computer-readable storage medium having embedded thereon program code for implementing the method.

A related system for answering a query of semistructured data includes an answer automaton constructor and an answer automaton engine. The answer automaton constructor constructs an answer automaton, based at least in part on the query. Constructing the answer automaton includes removing redundant symbols from the answer automaton. The answer automaton engine applies the answer automaton to the data to answer the query.

Another method of the present invention, for answering a query of semistructured data, includes four steps. In the first step, a finite query automaton, is constructed for the query. In the second step, an alphabet that is accepted by the finite query automaton is mapped into a set of transition indices of the finite query automaton, thereby transforming the finite query automaton into an isostate query automaton. In the third step, the isostate query automaton is transformed into an answer automaton, for example by merging the isostate query automaton with a schema automaton. In the fourth step, the answer automaton is applied to the data to answer the query.

A related device for processing semistructured data includes a memory in which is stored executable code for implementing the method to answer a query of the data and a processor for executing the code. Preferably, the device also includes a network interface for receiving the data from a network.

The scope of the present invention also includes a computer-readable storage medium having embedded thereon program code for implementing the method.

A related system for answering a query of semistructured data includes a query automaton constructor, an answer automaton constructor and an answer automaton engine, The query automaton constructor constructs, for the query, a finite query automaton, and maps an alphabet that is accepted by the finite query automaton into a set of transition indices of the finite query automaton, thereby transforming the finite query automaton into an isostate query automaton. The answer automaton constructor transforms the isostate query automaton into an answer automaton. The answer automaton engine applies the answer automaton to the data to answer the query.

### BRIEF DESCRIPTION OF THE DRAWINGS

The invention is herein described, by way of example only, with reference to the accompanying drawings, wherein:

FIG. 1 shows an outline of XML processing;

FIG. 2 is an example of a finite state machine that accepts the language L={w|w has both an even number of 0's and an even number of 1's};

FIG. 3 shows the algorithmic flow of the sequential application of the offline and online algorithms of the present invention;

FIG. 4 is an example of an XML schema;

FIG. 5 illustrates the DFA_{Schema} constructed from the XML schema of FIG. 4;

FIG. 6 shows a deterministic finite automaton that defines the language of the regular expression “ab(n)*c”;

FIG. 7 shows an example of alternate-single transition-sequences, “/root/a/b” and “root/a/a/b”;

FIG. 8 shows an example of alternate-double transition-sequences, “/root/c/d”; and “/root/d”;

FIGS. 9a-9d illustrate the removal of an unbound XPath-expression element d from the XPath-query /root//d/e;

FIG. 10 is pseudocode for the DFA reduction of the offline algorithm of the present invention;

FIGS. 11a-11d show an example of the reduction process of the offline algorithm of the present invention;

FIG. 12 shows the application of Algorithm 1 to the DFA_{Schema} of FIG. 5 and the XPath-query “/root/c/d”;

FIG. 13 is pseudocode for the online algorithm of the present invention;

FIG. 14 shows an XML document whose processing by the online algorithm of the present invention is illustrated in Table 1;

FIG. 15 shows the DFA_{minXpath} that is used in the processing illustrated in Table 1;

FIG. 16 shows the mapping of the DFA_{Schema} alphabet (a, b, c) onto the indices of the DFASchema transitions (1, 2, 3 and 4);

FIG. 17 shows the mapping of the DFA_{Schema} and the XPath-query of FIG. 11 onto transition symbols FIGS. 18a-18e show the reduction of the DFA_{Schema} of FIG. 17;

FIG. 19 is pseudocode of the DPDT parser of Averbuch et al. '307 as modified for the present invention;

FIG. 20 illustrates the extended algorithm of the present invention;

FIGS. 21 and 22 are partial high-level block diagrams of system for implementing the present invention;

FIGS. 23 and 24 are partial high-level block diagrams of hardware implementations of the present invention.

### DESCRIPTION OF THE PREFERRED EMBODIMENTS

The principles and operation of XML query processing according to the present invention may be better understood with reference to the drawings and the accompanying description.

In what follows, we first describe the basic algorithm of the present invention and then describe the extended algorithm of the present invention. The prior art methods discussed above are designed to handle many concurrent XPath-queries. The extended algorithm of the present invention uses the basic algorithm of the present invention to handle a large number of XPath-queries as well.

One unique advantage of the present invention over prior art methods is that the optimization of the present invention works well also with small collections of queries.

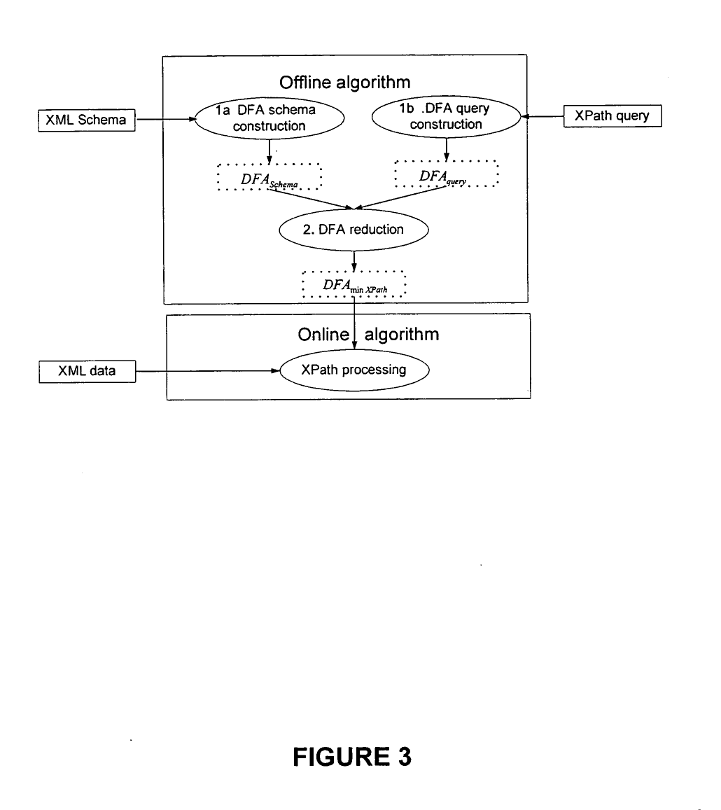

Referring again to the drawings, the basic algorithm of the present invention (FIG. 3) is divided into two sequential parts:
1. Offline—constructs a DFA with minimal alphabet, denoted hereinafter by DFA_{minXPath}, which accepts L_{answer} over the minimal alphabet.
2. Online—uses the DFA_{minXPath} from the Offline part to provide an answer to an XPath-query in the XML data.

The offline part is called first and once. The offline part is called when a new XPath-query is assigned. The online part is iteratively called each time a document is streamed to the system.

The input to the offline algorithm is an XPath-query and a XML-Schema. The offline algorithm has the following consecutive parts:
1. DFA construction: Constructs:
   a. DFA_{schema} from the input schema
   b. DFA_{query} from the input XPath-query
2. DFA reduction: generates a DFA with a minimal alphabet that accepts L_{answer}. This DFA is denoted herein by “DFA_{minXPath}”.

In FIG. 3, the operations are enclosed in ovals and the outputs of the operations are enclosed in dotted boxes.

The basic algorithm, whose three components are illustrated in FIG. 3, processes the XML data syntactically and semantically using formal language methodology. The basic algorithm defines the XML data as a formal language Lᵣₒₒₜ. Lᵣₒₒₜ accurately characterizes the aspects of the semistructured data that are needed to optimize the query processing. Lᵣₒₒₜ contains only finite words. Therefore, Lᵣₒₒₜ belongs to the class of regular languages.

Formal languages have been used before to define XML and other semistructured data. For example, tree languages are widely recognized as a presentation for semistructured data. But all these languages are too general to provide efficient algorithms to process queries.

The basic algorithm defines L_{query} and L_{schema} as regular languages. The initial step of the basic algorithm constructs a DFA_{schema} that accepts L_{schema}, from the XML Schema. The construction is denoted by “1a” in the basic algorithm in FIG. 3. The DFA_{schema} can also be constructed directly from Lᵣₒₒₜ using grammatical induction methods. The use of schema, as it is defined above, is unique to the present invention.

The basic algorithm defines the query as a RE. The DFA, that is constructed from this RE, accepts L_{query}. This DFA is denoted herein by “DFA_{query}”.

The overall combined framework of the offline algorithm includes:
1. Constructions of DFA_{schema} and DFA_{query};
2. Manipulation (explained below) of the DFA_{schema} and the DFA_{query} to produce the DFA that accepts L_{answer} on a reduced alphabet language.

The DFA, which accepts L_{answer}, is denoted hereinafter by DFA_{answer}. DFA_{minXPath} is the DFA_{answer} with the minimal alphabet.
3. Answer the query by intersecting L_{answer}∩Lᵣₒₒₜ. The intersection is done by applying DFA_{minXPath} to Lᵣₒₒₜ.

Steps 1 and 2 belong to the offline algorithm, while step 3 is the core of the online algorithm.

The present invention uses three operations on DFA_{schema} and DFA_{query}:
1. Intersection: DFA_{answer}=DFA_{schema}∩DFA_{query}.
2. Completion: DFA_{complement}=DFA_{schema}∩ D̅F̅A̅_̅{̅q̅u̅e̅r̅y̅}̅. DFA_{complement} is the complement of DFA_{answer}, in other words, DFA_{schema}=DFA_{answer}∪DFA_{complement}.
3. Symbol removal: removes a symbol s from Σ*. Let hₛ be the homomorphism

$${h}_{s} \text{:} \sum \to Δ {=}^{Δ} \sum / s$$

$$such that$$

$${h}_{s} ( a ) = \{ \begin{matrix}a & a \neq s \\ ɛ & otherwise \end{matrix}$$

where ε is the empty string. The homomorphism hₛ is applied on alphabet Σ for L. After the removal of the symbol s, the language L is denoted by L^{-s}. A DFA that accepts the language L can be modified to accept the language L^{-s}. The modified DFA, which accepts L^{-s}, is denoted herein by DFA^{-s}

We define “redundant symbols” as follows: A symbol s is redundant in DFA_{answer} if and only if DFA^{-s}_{answer}∩DFA^{-s}_{complement}=Ø. If the symbol s is non-redundant, then there are two words w₁∈L_{answer} and w₂∈L_{complement} that are merged to be the same word w after the removal of the symbol s. A non-redundant symbol is also called a “necessary symbol”.

### The Basic Algorithm: Pseudocode

The following pseudocode (“Algorithm 1”) is pseudocode for the offline part in the basic algorithm of FIG. 3. This pseudocode removes redundant symbols from DFA_{answer}.

```
Inputs: XML Schema, XPath-query
Locals: DFA_{answer} , DFA_{schema} , DFA_{query} , DFA_{complement}
Return: DFAₘᵢₙ_{_{XPath}}
Processing:
  Construction of DFA_{schema} from XML Schema
  Construction of DFA_{query} from XPath-query
  DFA_{answer} ← DFA_{schema} [symbol] DFA_{query}
  while there exists a symbol s ∈ Σ_{answer} such that DFA^{-s}_{answer} [symbol] DFA⁻
    ^{s}_{complement}=Ø do
    DFA_{answer} ← DFA^{-s}_{answer}
    DFA_{complement}←DFA^{-s}_{complement}
  end while
  DFAₘᵢₙ_{_{XPath}} ← DFA_{answer}
End Processing
```

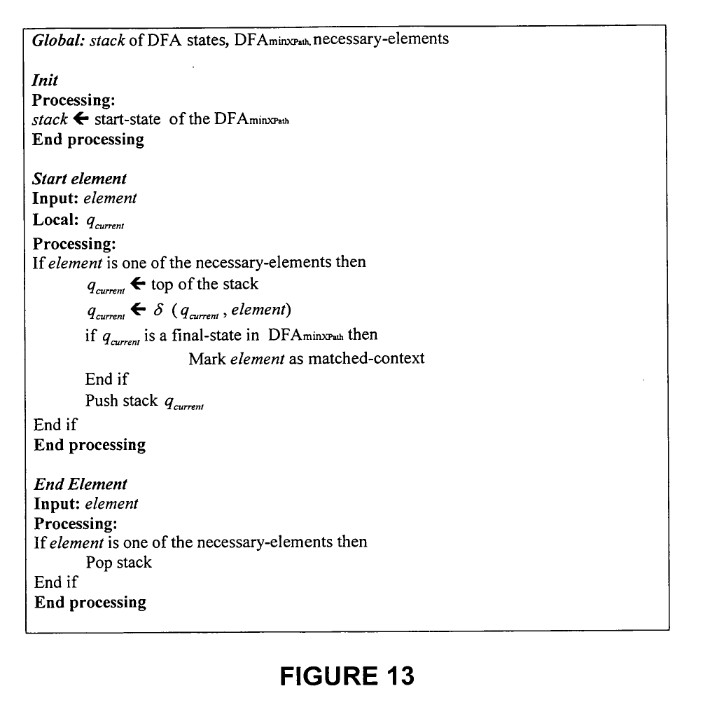

The following pseudocode (“Algorithm 2”) is pseudocode for the online part of the basic algorithm of FIG. 3. This pseudocode applies the DFAₘᵢₙ_{_{XPath}} on a single input path P, P∈Lᵣₒₒₜ. The online basic algorithm is extended below to process multiple paths that share common prefixes (see FIG. 13).

The online pseudocode handles two transition types:
Transitions of DFAₘᵢₙ_{_{XPath}};
Transitions of redundant symbols.

```
Inputs: PathP in Lᵣₒₒₜ
  DFAₘᵢₙ_{_{XPath}} = (Σ,Q,δ,q₀,F)
Locals: state q_{current}
Return: YES if P is an answer of the XPath-query and NO otherwise.
Processing:
  q_{current} ← q₀
  while there exists a next symbol s in P do
    if s ∈ Σ then
      if δ(q_{current},s) in δ then
        q_{current} ← δ(q_{current},s)
      end if
    end if
  end while
  if q_{current} ∈ F then return YES else return NO
End processing
```

### The Basic Offline Algorithm when L_{schema} is an IL

If the symbol s is non-redundant, then, the two words w∈L_{answer} and w∈L_{complement}, which differ only in s, become the same word after the removal of s. The transitions of DFA_{answer} and DFA_{complement} are δ_{answer}=δ_{schema}×δ_{query} and δ_{complement}=δ_{schema}× δ̅_{query} respectively. The special structure of an IA ensures that the words w and w′ are derived from a similar sequence of transitions in δ_{schema}. The two sequences of transitions are identical except the transitions to and from a single state that produces the symbols. Because of this similarity, we can identify a non-redundant symbol s in an IA by locally examining transitions that accept s and their neighboring transitions in the sequence. The DFA reduction (“2” in FIG. 3) constructs the transition patterns that identify non-redundant symbols.

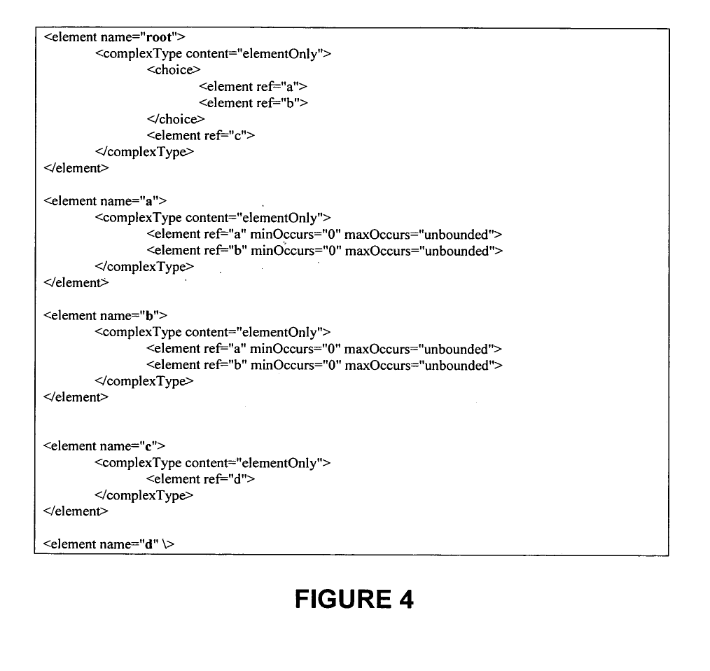

FIG. 4 is an example of an XML Schema that we use in the following presentation to demonstrate various features of the algorithm of the present invention. This XML-Schema defines a “root” element with children elements “a” or “b” followed by element “c”. The elements “a” and “b” contain any combinations of the children elements “a” and “b”. The element “c” has a single child—the empty element

We construct the DFA_{Schema} from the XML Schema as follows:
1. The alphabet is a set of elements as defined in the XML Schema.
2. The states include one state for each element a in the XML Schema.
3. There exists a transition from a state A to a state B if according to the XML Schema element b is a possible child of element a.
4. The start state is an additional state with a transition to the root element state.
5. The final states are the states of all possible empty elements, where an “empty element” is an element with no children.

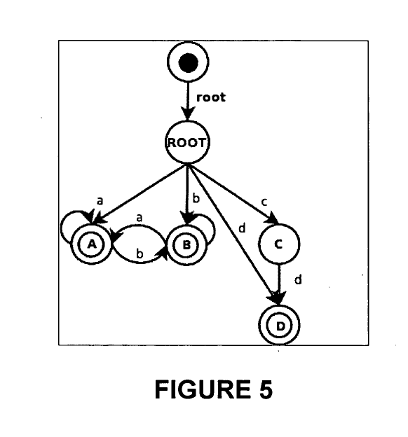

FIG. 5 illustrates the DFA_{Schema} constructed from the XML-Schema presented in FIG. 4. The DFA_{Schema} is constructed in the following way:
1. The alphabet (denoted by small letters): root, a, b and c
2. The states (denoted by capital letters): ROOT, A, B and C.
3. The final states (denoted by a double circle): A, B and D.

FIG. 5 shows that the constructed DFA is an IA.

We describe now the DFA reduction scheme when L_{schema} is an IA. The inputs to the DFA reduction process are the DFA_{schema} that is constructed in step “1a” of FIG. 3 and the input XPath-query. This algorithm does not remove symbols from the DFA_{answer}. Instead, the algorithm removes redundant symbols from both inputs. Here, removal of symbol s (also called element removal) means: 1. Application of the homomorphism hₛ on DFA_{Schema} that generates DFA_{schema}^{-s}; and 2. Removal of XPath-expressions that contain the element s from the XPath-query.

After the removal of all the redundant symbols from both inputs, which is described next, the algorithm constructs the DFA_{Schema} with minimal alphabet that is called DFAₘᵢₙ_{_{schema}}. In addition, the algorithm reduces the redundant XPath-expressions. The algorithm constructs the DFA_{query} of the reduced XPath-query, which is called DFAₘᵢₙ_{_{query}}. The algorithm constructs DFAₘᵢₙ_{_{Xpath}}=DFAₘᵢₙ_{_{schema}}∩DFAₘᵢₙ_{_{query}}.

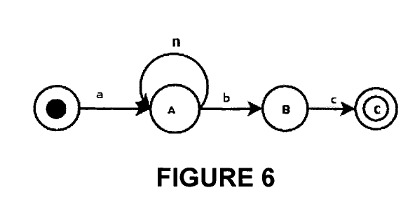

The first step in this reduction process checks if the XPath-query is valid for the schema. If the XPath-query is valid we identify the necessary-elements that can not be removed from the alphabet. For example, the element n in FIG. 6 is a necessary-element for the matching of the XPath-query ‘/a/b/c’. If the element n is removed from the alphabet of DFA_{schema}, then the self-transition in state A in DFA_{schema}⁻ⁿ does not exist. After the removal of n, we are unable to determine if the transition-sequence from start-state to A, from A to B and from B to C originally matched the context ‘/a/b/c’. The original sequence may contain self-transitions n in state A. In this case, the original sequence does not match the context ‘/a/b/c’. A removal of the necessary element n causes two transition-sequences, that differ only by this element, to be identical. We call these two transition-sequences “alternate transition-sequences”. In other words, alternate transitions-sequences are two different transitions-sequences that share the same start-state and end-state. The two alternate transitions-sequences complement each other in their matching successes. For example, FIG. 6 shows a DFA that defines the language of the regular expression “ab(n)*c”. In FIG. 6, the transition-sequences 1) from start-state to A, from A to B and from B to C, 2) from start-state to A, from A to A, from A to B and from B to C, are alternate transition-sequence because sequence 1 matches the context ‘/a/b/c’ while sequence 2 does not match sequence ‘/a/b/c’ and the two sequences differ from each other by a single element n.

To remove an element from the alphabet, all the alternate transitions-sequences that differ only by this element are examined. Because DFA_{Schema} is an IA, it suffices to check only alternating transition-sequences that are different from each other by at most two transitions:
1. Alternate-single-transitions—different in a single self-transition
2. Alternate-double-transition—different in two transitions

Alternate transitions-sequences generate two words w∈L_{answer} and w′∈L_{complement} that are different from each other by a single element s. For α,β∈Σ*, the element is one of two types:
1. Internal—w=αsβ and w′=αβ.
2. External—w=αβand w′=αsβ.

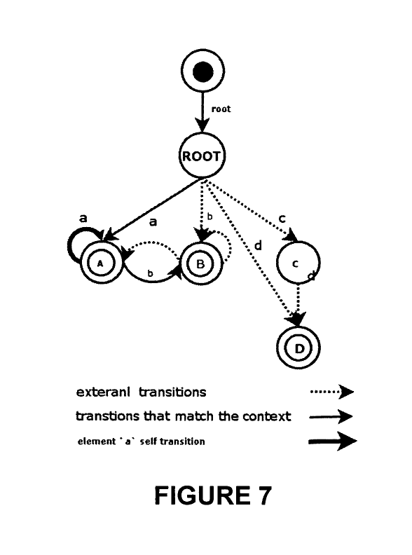

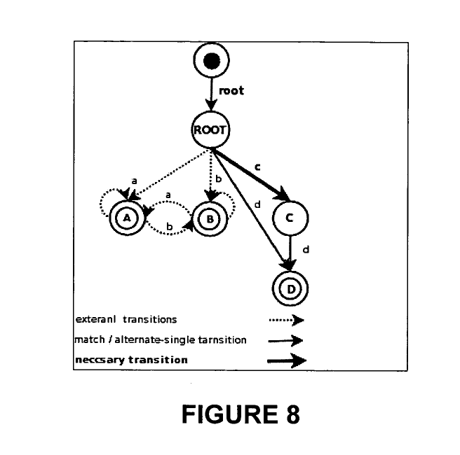

We now classify the occurrences of alternate transitions-sequences. Altogether there are four alternate transition-sequence patterns:
1. External-single: In this case, the element s is accepted by a self-transition where w=αβ and w′=αsβ. From the removal of element s, αβ∈L_{answer}^{-s} and αβ∈L_{complement}^{-s}. Therefore, s is not redundant. FIG. 7 illustrates this pattern for the XPath-query ‘\root\ab’. Let w=“root a b” and w′=“root a a b”. The self-transition a is part of the transition sequence from start-state to ROOT, from ROOT to A, from A to A and from A to B that accepts w′. This transition-sequence alternates with the transition sequence from start-state to ROOT, from ROOT to A and from A to B that accepts w.
2. Internal-single: In this case, the element s is accepted by a self-transition where w=αs,β and w′=αβ. From the removal of element s, αβ∈L_{answer}^{-s} and αβ∈L_{complement}^{-s}. Therefore, s is not redundant. Let w=“root a a b” and w′=“root a b”. FIG. 7 shows this pattern for the XPath-query ‘\root\a\a\b’. The self-transition a is part of the matched transition sequence from start-state to ROOT, from ROOT to A, from A to A and from A to B that accepts w. This transition sequence alternates with the transition sequence from start-state to ROOT, from ROOT to A and from A to B that accepts w.
3. Internal-double: Assume we have three states A, B and C. A is connected to B that accepts s, B to C that accepts c and A to C that accepts c. Assume that w=αscβ and w=αcβ. From the removal of element s, αcβ∈L_{answer}^{-s} and αcβ∈L_{complement}^{-s}. Therefore, s is not redundant. Let w=“root c d” and w′=“root d”. This pattern is illustrated in FIG. 8. In FIG. 8, for the XPath query ‘\root\c\d’ there are three states ROOT, C and D. ROOT is connected directly to C and C to D, and ROOT is also connected directly to D. In this case, the transition sequence from start-state to ROOT from ROOT to C and from C to D that accepts w, alternates with the transition sequence from start-state to ROOT from ROOT to D that accepts w′.
4. External-double: We use the same pattern as in pattern 3. In pattern 3, the two transitions (A to B and B to C) belong to the sequence that accepts w=αscβ. Here, the single transition A to C belongs to sequence that accepts w=αcβ. This pattern is illustrated in FIG. 8. For the XPath query ‘\root\d’ there are three states ROOT, C and D. ROOT is connected directly to C and C to D, and ROOT is also connected directly to D. In this case, the transition sequence from start-state to ROOT and from ROOT to D, that accepts w, alternates with the transition sequence from start-state to ROOT and from ROOT to C and from C to D that accepts w′.

In FIG. 7, we check whether element ‘a’ can be removed from the alphabet.

We check this for three different XPath-queries contexts:
1. Element ‘a’ in ‘/root/a/b’ is necessary because the transition that accepts ‘a’ is part of an external-single transition pattern (pattern 1). This pattern indicates the existence of two alternate transition sequences: 1. start-state to ROOT, ROOT to A and A to B; 2. start-state to ROOT, ROOT to A, A to A and A to B
2. Element ‘a’ in ‘/root/a/a/b’ is necessary because the transition that accepts ‘a’ is part of an internal-single transition pattern (pattern 2).

This pattern indicates the existence of two alternate transition sequences: 1. start-state to ROOT, ROOT to A and A to B; 2. start-state to ROOT, ROOT to A, A to A and A to B.
3. Element ‘a’ in ‘/root//a/b’ is redundant because two transition-sequences match the context ‘/root//a/b’. The sequences are: 1. start-state to ROOT, ROOT to A, A to A and A to B; 2. start-state to ROOT, ROOT to A and A to B.

In FIG. 8 we check whether element ‘c’ can be removed from the alphabet. We check this for three different XPath-queries contexts:
1. Element ‘c’ in ‘/root/c/d’ is necessary because the transition that accepts ‘c’ is part of an internal-double transition-sequence (pattern 3). This pattern indicates the existence of two alternate transition sequences: 1. start-state to ROOT, ROOT to C and C to D; 2. start-state to ROOT, ROOT to D.
2. Element ‘c’ in ‘/root/d’ is necessary because the transition that accepts ‘c’ is part of an external-double transition-sequence (pattern 4). This pattern indicates the existence of two alternate transition sequences: 1. start-state to ROOT, ROOT to C and C to D; 2. start-state to C, C to D.
3. Element ‘c’ in ‘/root//d’ is redundant because two transition-sequences match the context: 1. start-state to ROOT, ROOT to C and C to D; 2. start-state to ROOT and ROOT to D.

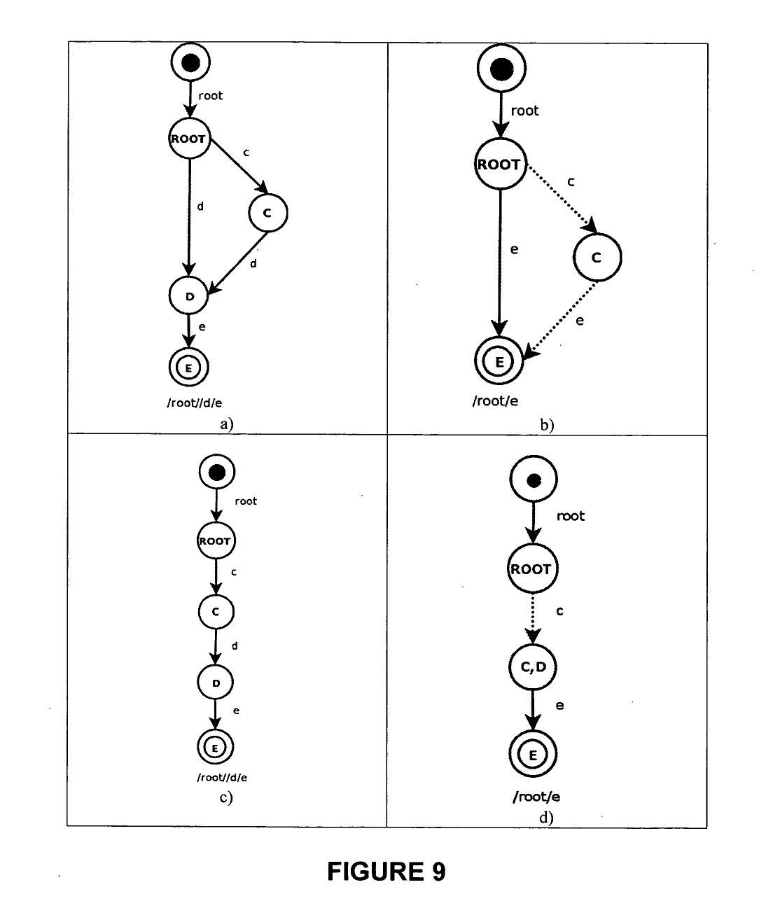

When we remove an unbound XPath-expression element, the reduction algorithm may produce an invalid XPath-query. Removal of an element is possible when a scenario of the type illustrated in FIG. 9 occurs. FIGS. 9a-9d show two examples of removal of an unbound XPath-expression element d from the XPath-query root//d/e. FIG. 9a shows the source schema of the first example. FIG. 9b shows the results after the removal of d from the source schema of FIG. 9a. FIG. 9c shows the source schema of the second example, FIG. 9d shows the results after the removal of d from the source schema of FIG. 9c. Element d in ‘/root//d/e’ (FIG. 9a) can be removed because transition d from ROOT to D exists. The removal of d merges the states ROOT and D. Therefore, the valid XPath-query, ‘/root//d/e’, that has a transition-sequence to E, remains valid when ‘/root//d/e’ is reduced to ‘/root/e’ as shown in FIG. 9b. The XPath-query ‘/root//d/e’ becomes invalid when transition d from state ROOT to state D does not exist (FIG. 9c). In this case, the accepted query ‘/root/e’ is invalid because the transition from ROOT to C disconnects between the transition from start-state to ROOT and the transition from C to E (see FIG. 9d).

The last XPath-expression element is always a necessary-symbol. For example, this is demonstrated by the XPath-query ‘/root/e’ in FIG. 9b. Element ‘e’ in this XPath-query is necessary. If we remove the element ‘e’, we get the XPath-query ‘/root’. But we can not determine if the matched context is either ‘/root/e’ or ‘/root’.

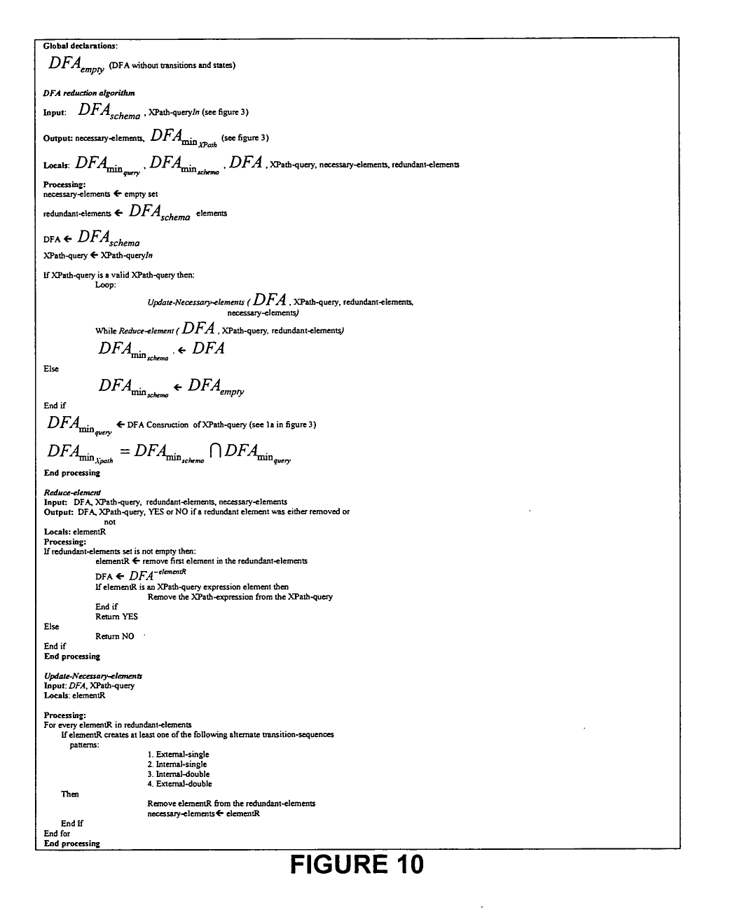

FIG. 10 shows pseudocode for the DFA reduction (part “2” in FIG. 3) in the offline algorithm.

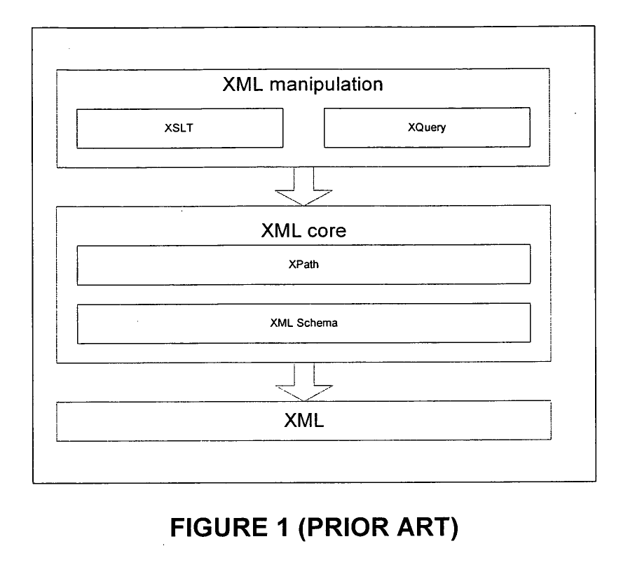

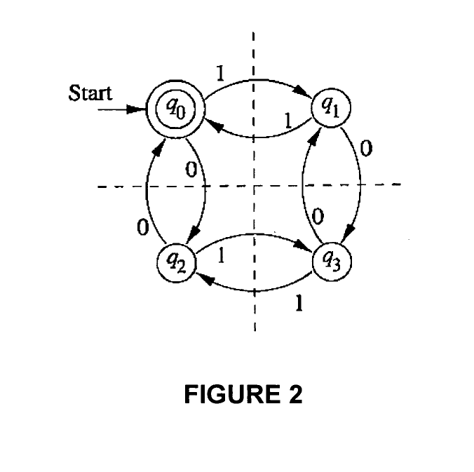

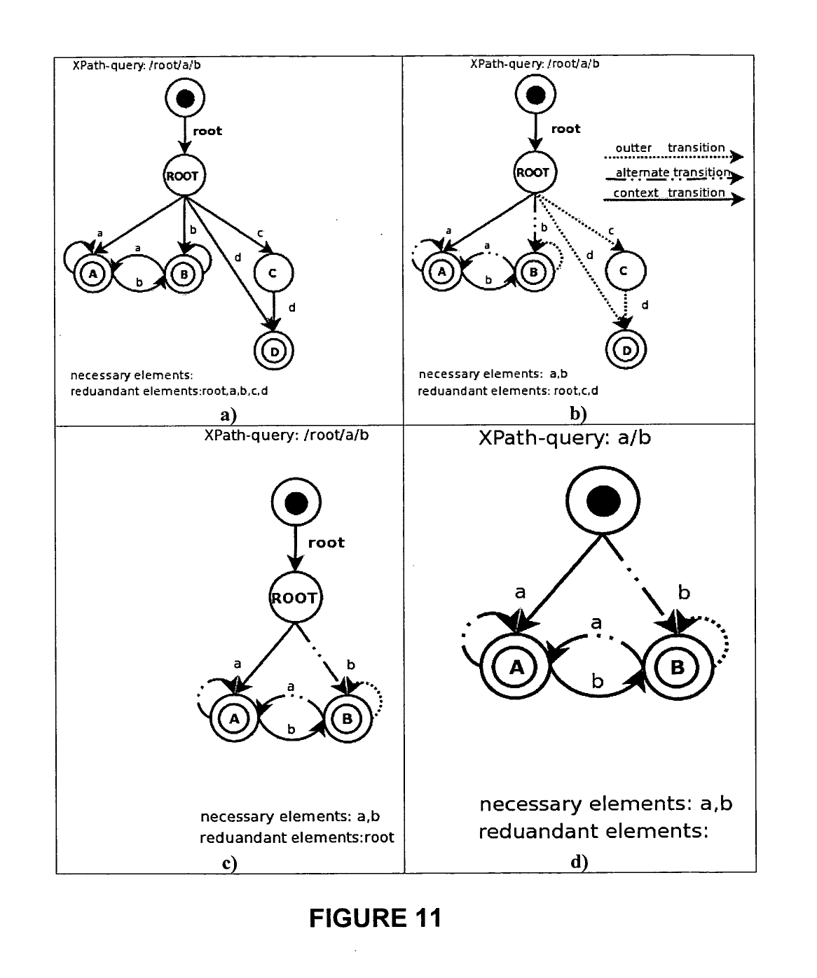

FIGS. 11a-11d show an example of the flow of the DFA reduction process of the offline algorithm for the XPath-query ‘/root/a/b’ and the DFA_{Schema} in FIG. 7. FIG. 11a shows the initial state. Element ‘a’ in FIG. 11b is accepted by a transition that is part of the sequence that accepts w=“root a b”. Element ‘a’ is a necessary-element because the transitions that accepts “a” are part of two transition patterns: a single-external transition pattern that indicates the alternate transition sequence that accepts w=“root a a b” and the double-internal transition pattern that indicates the alternate transition sequences that accepts w′=“root b”. Element ‘b’ in FIG. 11b is a necessary-element because a transition that accepts “b” is part of a double-external transition pattern. The transition pattern indicates that two alternate transition sequences exist that accepts: 1. w=“root a b”; 2. w′=“root b a b”. FIG. 11c shows the DFA_{schema} of FIG. 7 after the reduction of elements c and d. FIG. 1d shows the reduction of the root element.

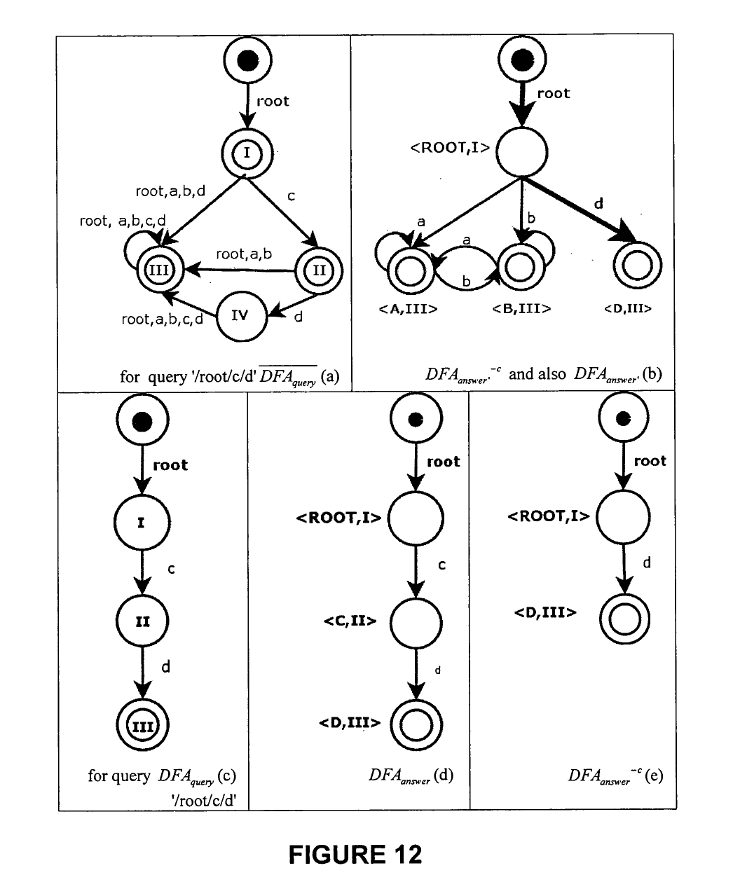

Two different procedures have been given herein for the removal of redundant elements. One procedure is presented above as the pseudocode of Algorithm 1. The other procedure is presented in FIG. 10. The two procedures are equivalent. In Algorithm 1 we use DFA_{answer} and DFA_{complement}. In FIG. 10, we use the notion of alternate transition sequence. We show now, using the example of FIG. 12, that DFA_{answer} and alternate transition sequences are interchangeable.

In FIG. 10, the offline algorithm processes two alternate transition sequences on DFA_{schema} (FIG. 5). One transition sequence accepts the word w=“root c d”∈L_{answer} and the other transition sequence accepts the word w=“root d” ∈L_{complement}. The transitions sequences are labeled ‘internal’ and ‘external’ to differentiate between these two sequences. The ‘external’ transition sequence of root.d is accepted by DFA_{answer}, (FIG. 12b) which is constructed from the intersection of D̅F̅A̅_̅{̅q̅u̅e̅r̅y̅}̅ (FIG. 12a) and DFA_{schema} (FIG. 5). The ‘internal’ transition sequence of “root c d” is accepted by DFA_{answer} (FIG. 12d) which is constructed from the intersection of DFA_{query} (FIG. 12c) and DFA_{schema} (FIG. 5). The algorithm in FIG. 10 does not allow to remove the symbol c because symbol c generates an alternate-double-transition-sequence pattern. The alternate transitions sequence accepts two words: “root c d”∈L_{complement}. and “root d”∈L_{complement}. The two words differ only in symbol c. Algorithm 1 also does not allow to remove the symbol c. The removal of symbol c from the alphabet by the homomorphism in Algorithm 1 is illustrated in FIG. 12e.

(The homomorphism is described by DFA_{answer}^{-c}) Algorithm 1 considers symbol c as a necessary-symbol because the intersection between DFA_{answer}^{-c} (FIG. 12e) and DFA_{complement}^{-c} (FIG. 12b) is not empty since the word root.d exists in both. Therefore, an alternate transition sequence indicates that the intersection L_{answer}^{-c∩L}_{complement}^{-c}≠Ø. The word that is accepted by the transitions-sequence after removing symbol c is in the intersection.

### The Online Algorithm

The online algorithm accepts a stream of XML data, necessary-elements and DFA_{minXPath}, which are the two outputs from the offline algorithm, and provides as an output the XML elements that match the context. The algorithm processes each element sequentially. The element can be a start-element or an end-element. The necessary-elements and DFA_{minXPath} are treated as global data.

The online algorithm uses a stack to store the DFA_{minXPath} states. The states identify the common prefixes of the paths processed so far. At any given time there is a single active state. The algorithm uses the XML parser of Averbuch et al. '307 to implement the pseudocode of the online algorithm. The algorithm has three procedures that are called during the application of the XML parser:
1. Initialization in setup time
2. Receiving a start-element from the XML stream
3. Receiving an end-element from the XML stream
Pseudocode that describes the online procedures is given in FIG. 13.

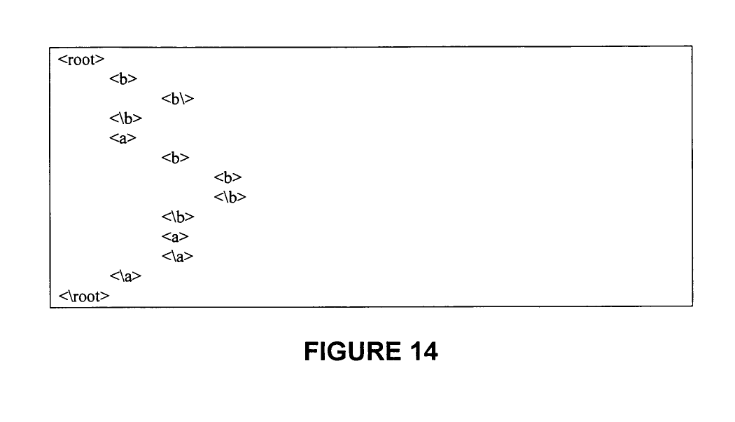

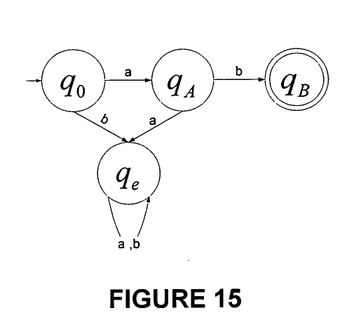

We demonstrate the operation of the online algorithm in Table 1 on the XML document shown in FIG. 14 and on the DFA_{minXPath} in FIG. 15. The stack alphabet of Table 1 contains the DFA_{minXPath} states Q={q₀,q_{A},q_{B},qₑ} of FIG. 15.

TABLE 1

| Symbol | Stack | Operation | Matching |
|---|---|---|---|
| | q₀ | Init | |
| <root> | q₀, | Start - skipped | |
| <b> | q₀, qₑ | Start | |
| <b\> | q₀, qₑ | Start, End | |
| <\b> | q₀, | End | |
| <a> | q₀, q_{A} | Start | |
| <b> | q₀, q_{A}, q_{B} | Start | Bingo! |
| <b> | q₀, q_{A}, q_{B}, qₑ | Start | |
| <\b> | q₀, q_{A}, q_{B} | End | |
| <\b> | q₀, q_{A}, | End | |
| <a> | q₀, q_{A}, qₑ | Start | |
| <\a> | q₀, q_{A} | End | |
| <\a> | q₀, | End | |
| <\root> | q₀ | End - skipped | |

Two different procedures are given herein for the XML online processing of XPath queries. The pseudocode of Algorithm 2 presents one procedure. The other procedure is presented in FIG. 13. FIG. 13 is an extension of Algorithm 2. In Algorithm 2, a single path from the XML root to its leaf is processed. For a single path, it is sufficient to store a single state q_{current} that belongs to DFA_{minXPath}. FIG. 13 describes XPath processing on all the paths in the XML tree. Processing each path alone is inefficient. The algorithm in FIG. 13 shares the processing of the common sub-paths from the root. After processing the common sub-paths, the states are stored in a stack.

Algorithm 2 processes the XML path iteratively. The algorithm in FIG. 13 contains the procedures that are called during the application of the XML parser of Averbuch et al. '307. The XML parser routine traverses the XML tree and uses the XPath procedures in the same iterative way Algorithm 2 processes the q_{current} updates inside the while-loop.

### Mapping the Transition Alphabet

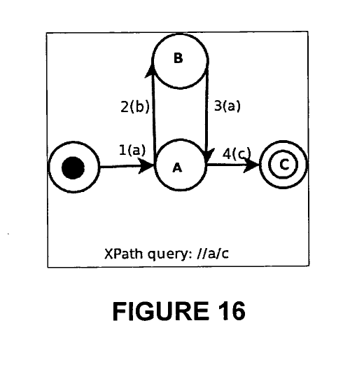

Assume each element in the alphabet is mapped into the set of DFA_{Schema} transitions indices that accept the alphabet. We call this index a ‘transition-symbol’ (denoted herein by TS). Formally, assume we have DFA={Q,Σ,δ,q₀,F}. Denote δₗ [symbol] δ(qᵢ,aⱼ)=qₖ,l=(i,j,k),aⱼ∈Σ,qᵢ,qₖ∈Q. We map the input symbol aⱼ to a new set of symbols denoted by l, which constitute the new alphabet. The collection of symbols l constitute the new alphabet Σ′. The new transition, denoted by δ′ₗ, is δₗ [symbol] δ(qᵢ,l)=qₖ,l=Σ′,qᵢ,qₖ∈Q. For a given transition δₗ [symbol] δ(qᵢ,aⱼ)=qₖ,l=(i,j,k),aⱼ∈Σ,qᵢ,qₖ∈Q, then, for l=(i,j,k) the mapping is given by δ′ₗ [symbol] δ(qᵢ,l)=qₖ,l∈Σ′,qᵢ,qₖ∈Q. This mapping enables transformation of each DFA to an IA. Then the algorithm in FIG. 10 can be applied. TS provides a more detailed description of the transition assignments. Each symbol represents a transition. This way, the mapping enhances the performance because fewer transitions are used in the context matching. For example, TS 2 in FIG. 16 provides the information needed for matching the context ‘/a/b’. Therefore, we process only δ′₂ instead of processing both δ₁, and δ₂.

In order to increase the number of redundant symbols, we map the DFA_{Schema} alphabet into indices in DFA_{Schema} transitions. An example of such a mapping is given in FIG. 16 that shows the mapping of the DFA_{Schema} alphabet (a,b,c) to the indices of the DFA_{Schema} transitions (1, 2, 3 and 4). Element a is mapped into TS 1, which is

$${δ}_{1} {=}^{Δ} δ ( {q}_{0} , a ) = A ,$$

and TS 3, which is δ₃ [symbol] δ(B,a)=A. Element b is mapped into TS 2, which is

$${δ}_{2} {=}^{Δ} δ ( A , b ) = B ,$$

and element c is mapped into TS 4, which is

$${δ}_{2} {=}^{Δ} δ ( A , c ) = C .$$

Now we explain how to map an XPath-query to transition symbols. For example, in FIG. 16 we look for the XPath-query //a/c. The mapping of this XPath-query assigns the symbol a to TS 1 and to TS 3. The mapping also assigns the symbol c to TS 4. From these two assignments we get two XPath queries: 1) //TS 1/TS 4. 2) //TS 3/TS 4. Formally, each symbol s from the XPath-query expression is assigned the set Lₘ={l:l=(i,j,k),s=aⱼ∈Σ, qᵢ,qₖ∈Q} of TSs where m is the number of expressions in the sequence that composes the XPath-query. The XPath-query is assigned to the set of the Cartesian product Lₗ× . . . ×Lₘ where m is the number of expressions in the XPath-query. In the above example, m=2.

So we have a collection of Cartesian products Lₗ× . . . ×Lₘ where m is the number of expressions in the XPath-query. Each product is a translated XPath-query. If a symbol is redundant in all the valid XPath queries then the symbol is removed.

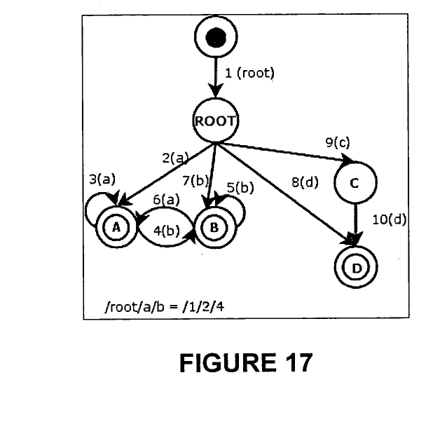

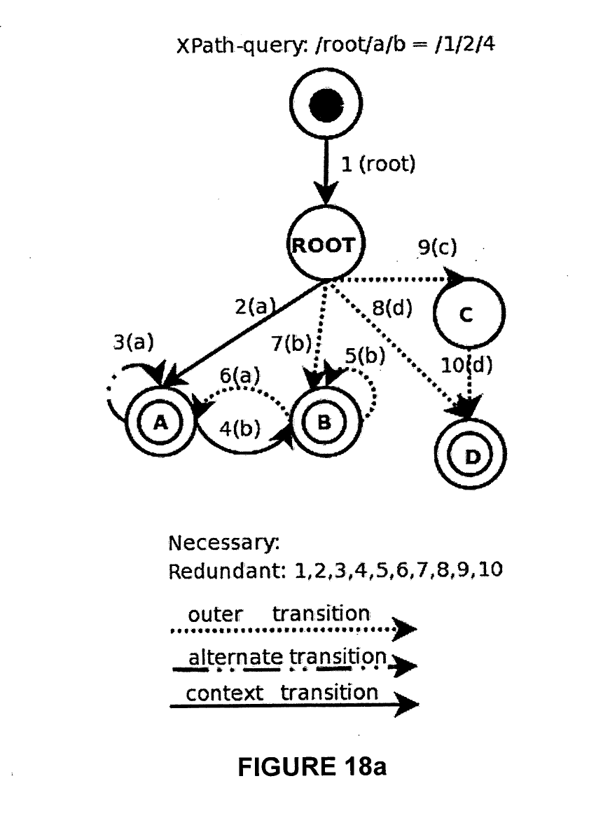

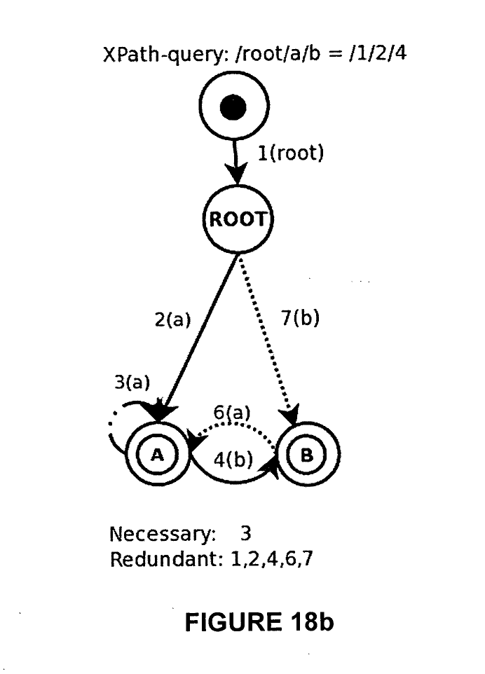

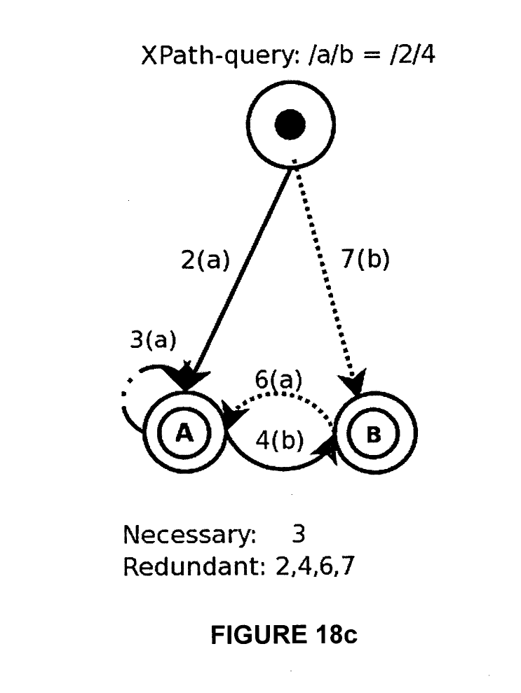

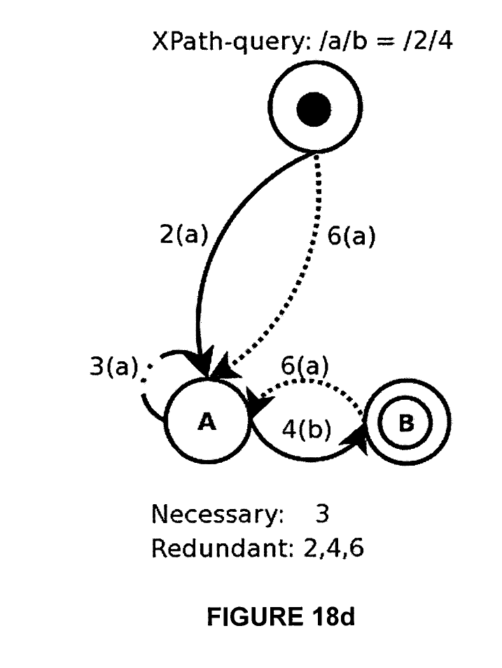

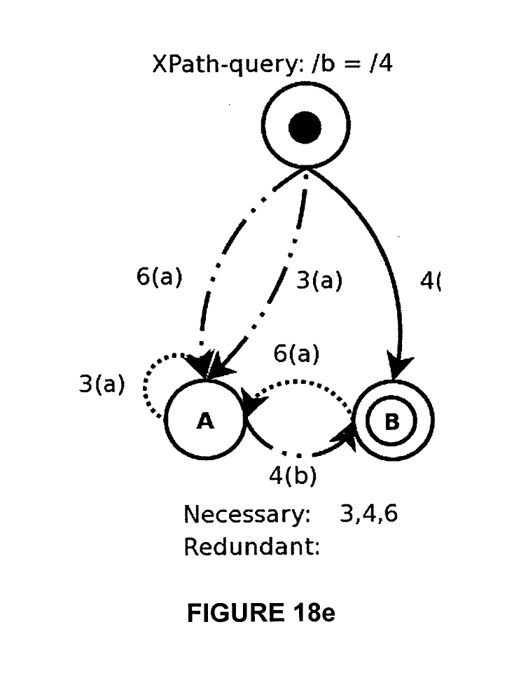

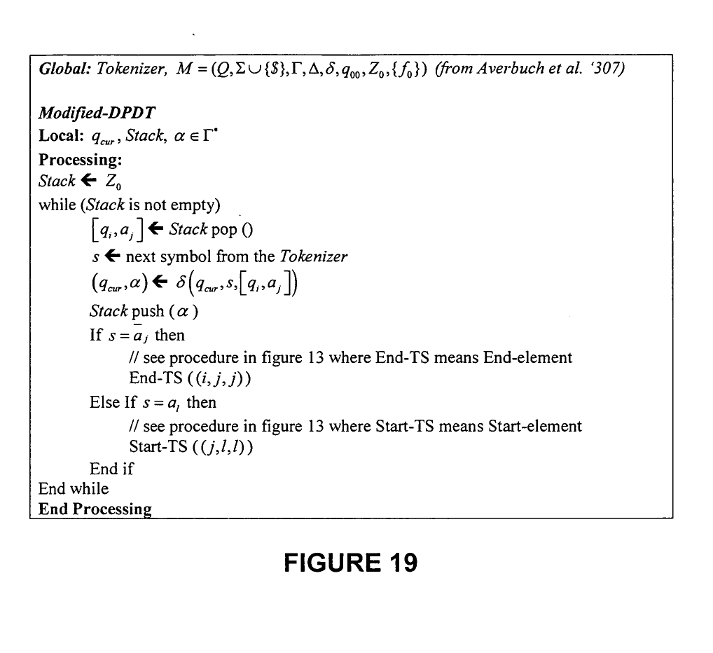

FIG. 17 shows the DFA_{Schema} and the XPath-query of FIG. 11 after having been mapped to transition symbols. The transition symbol of each element in parentheses is to the left of the element.

FIGS. 18a-18e show the reduction process of the DFA_{Schema} in FIG. 17. FIG. 18a shows the DFA_{Schema}. FIG. 18b shows the DFA_{Schema} after the removal of TS 5, 8, 9 and 10. We see that TS 3 is a necessary-TS because TS 3 creates an external-single alternate-sequence. In FIG. 18c, TS 1 is reduced. In FIG. 18d, TS 7 is reduced. Finally, in FIG. 18e, TS 2 is reduced. After the reduction, TS 6 creates a double-external alternate-sequence. TS 3 is still a necessary-TS but now TS 3 creates a double-external alternate-sequence.

In FIG. 18e, the reduction example is terminated by a DFA with three TSs. The original example in FIG. 11 is terminated by a DFA with six transitions. The reduction after the mapping reduces the number of transitions by factor of two.

The online algorithm translates the input symbols of Lᵣₒₒₜ into TSs. We use DPDT from Averbuch et al. '307 to translate the symbols. We replace the start-element and the end-element procedures in FIG. 13 with new procedures that are called Start-TS and End-TS. Start-TS and End-TS accept as an input a TS instead of an element. The TS is extracted from our XML-parser DPDT automata (see Averbuch et al. '307).

The DFA_{Schema} that is constructed from DPDT contains δ(qᵢ,aⱼ)=qⱼ such that /qᵢ,qⱼ∈Q,aⱼ∈Σ, and aⱼ always enters qⱼ. The TS of this DFA_{Schema} has the form {l:l=(i,j,j), s=aⱼ∈Σ,qᵢ,qⱼ∈Q}. DPDT is defined as follows:

$$M = ( Q , \sum ⋃ \{ \$ \} , Γ , Δ , δ , {q}_{00} , {Z}_{0} , \{ {f}_{0} \} )$$

$$where$$

$$Q = {{⋃}^{n}}_{i = 0} {Q}_{i}$$

$$\sum = \{ {a}_{1} , {\overline{a}}_{1} , {a}_{2} , {\overline{a}}_{2} , … , {a}_{n} , {\overline{a}}_{n} \} ⋃ {\sum }^{′} \\ Γ = \{ {Z}_{0} \} ⋃ \{ [ q , {a}_{j} ] \vert q ∈ {Q}_{i} , 0 \leq j \leq n \}$$

For each i in the Qᵢ in M there exists a unique qᵢ in the constructed DFA_{Schema}. From the top of the stack [q, aⱼ] we get the previous and the current states of the DFA_{Schema}. The previous state is the unique qᵢ that is constructed from the states Qᵢ, q∈Qᵢ, and the current state q_{cur} is qⱼ that accepts aⱼ. The new symbol scan be one of the following:
1. If s=āⱼ then the End-TS procedure is called with TS (i, j, j). The transition-symbol from Qᵢ to Qⱼ is not needed.
2. If s=aₗ then the Start-TS procedure is called with TS (j,l,l). The transition-symbol from Qⱼ to Qₗ is needed.
3. If s=Σ′ then the procedure in the XPath is not applied because q_{cur} remains in the same Qⱼ.

Pseudo code that describes the modifications of the DPDT algorithm and the adaptation of the DPDT algorithm to processing TSs is given in FIG. 19. In FIG. 19, the modified DPDT is denoted by “Modified-DPDT”.

### The System That Implements the Extended Algorithm

In the basic algorithm, a semistructured query states a pattern of semistructured model entities that is called a “context”. The XML standard allows a query to have more than one context. The context is arranged in a tree of contexts. The XML standard allows each context to include a Boolean expression that is calculated on the textual value of the matched node in the tree. The Boolean expression is written as a textual string. Therefore, this Boolean expression is called a “text expression” in this section.

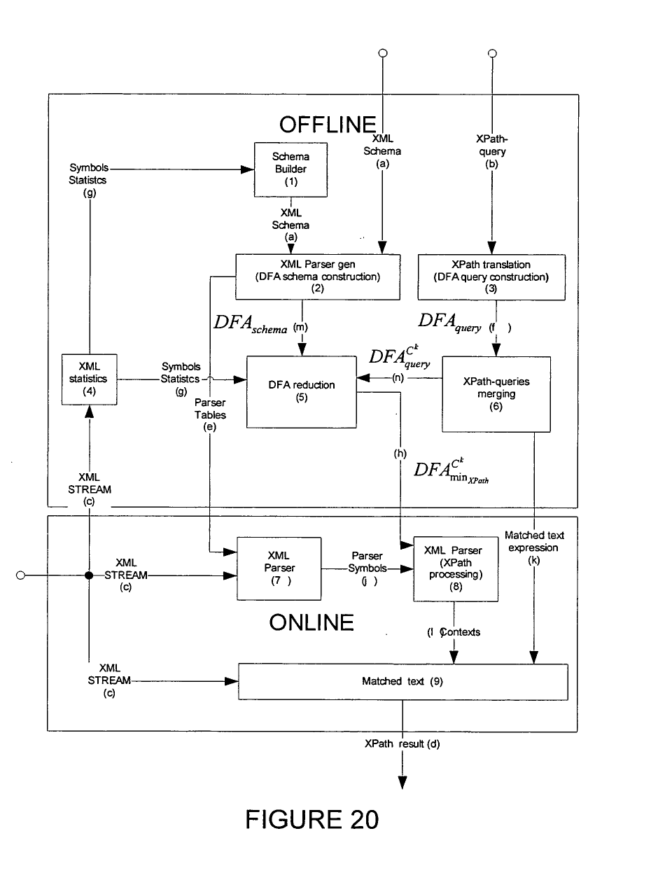

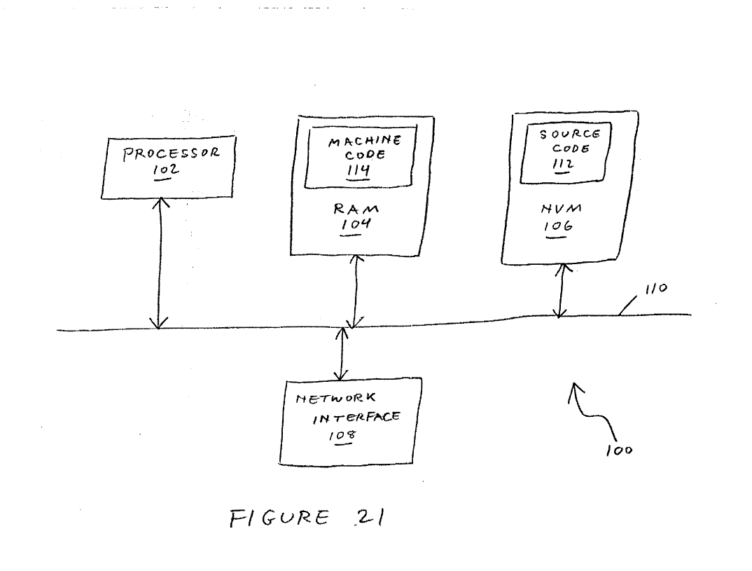

FIG. 20 shows how to extend the basic algorithm of the present invention to support many concurrent XPath-queries. The flow of the core components for XML processing system is given in FIG. 20. We start the top-down description of the flow from the input of the XML Schema. The system receives the XML schema as an input (denoted by a in FIG. 20). The XML parser-generator (denoted by 2 in FIG. 20), which is described in Averbuch et al. '307, generates a parser table with the XML symbols syntax (denoted by e in FIG. 20) for the XML-parser of this schema (denoted by 7 in FIG. 20). As a byproduct, the XML parser generator also produces the DFA_{Schema} (denoted by m in FIG. 20).

In addition, the system receives also a XPath-query as an input (denoted by b in FIG. 20). Then, the system translates the XPath-query (denoted by 3 in FIG. 20) into a query that fits streaming. The system creates, from the query that fits streaming, a DFA_{query} (denoted by f in FIG. 20) that is given to the XPath-uniting algorithm (denoted by 6 in FIG. 20).

The XPath-uniting adds the DFA_{query} to cluster C^{k}. The DFA_{query} of a cluster C^{k},k=1, . . . , K, which is denoted DFA_{query}^{C}^{^{k}} (denoted by n in FIG. 20), is given to the DFA reduction process (denoted by 5 in FIG. 20). K is the number of clusters.

For DFA_{query}^{C}^{^{k}} , the DFA reduction process constructs the DFAₘᵢₙ_{_{XPath}} from the DFA_{query}^{C}^{^{k}} This DFAₘᵢₙ_{_{XPath}} is denoted DFAₘᵢₙ_{_{XPath}}^{C}^{^{k}} (denoted by h in FIG. 20). The DFA reduction process outputs the DFAₘᵢₙ_{_{XPath}}^{C}^{^{k}} to the XML parser (denoted by 8 in FIG. 20) that processes the XPath-queries to find matched context.

The system receives streams of XML data as an input (denoted by c in FIG. 20). The XML stream is validated by the XML parser (denoted by 7 in FIG. 20) that is constructed from the generated parsing table (denoted by e in FIG. 20). The parser's symbols (denoted by j in FIG. 20) are the input to the XML parser (denoted by 8 in FIG. 20) that processes the XPath-queries to detect matched contexts.

The matched text expression is a Boolean expression represented by a string that is a part of the XPath query. This Boolean expression is applied on the textual value of the element that is matched by the query context (box 6). This text expression (denoted by k in FIG. 20) is the input to the matched text module (denoted by 9 in FIG. 20) that calculates the XPath Boolean expression on the matched texts. The output of the matched text module is the XPath-query result (denoted by d in FIG. 20). If needed, 8 in FIGS. 20 and 9 in FIG. 20 can be duplicated to run in parallel (concurrent) mode.

When the XML data does not have a schema, the system provides a mechanism to build a schema from the XML stream. The statistics of XML symbols occurrences is gathered (denoted by 4 in FIG. 20). The symbols statistics (denoted by g in FIG. 20) are input to the schema builder (denoted by 1 in FIG. 20) that constructs a schema for the XML stream. The symbols statistics (g) are also input to DFA reduction module (5) that can order the sequence of the removal of the symbols according to their sizes in the stream.

The extended algorithm (FIG. 20) is divided into two sequential parts:
1. Offline—constructs a DFAₘᵢₙ_{_{XPath}}^{C}^{^{k}} with minimal alphabet.
2. Online—uses the DFAₘᵢₙ_{_{XPath}}^{C}^{^{k}} from the Offline part to provide an answer to several concurrent XPath-queries in an XML stream.

a Description of each operational module in the flowchart of FIG. 20 is given in table 2.

TABLE 2

| Box # | Functionality description of the box |
|---|---|
| 1 | Constructs a scheme from a stream of XML symbols |
| 2 | Averbuch et al. ‘307 - “XML Parser” |
| 3 | See C. Bry and S. Schaffert, Towards a declarative query and transformation |
| | language for XML and semistructured data: simulation unification, Research |
| | Report PMS-FB-2002-2, Computer Science Institute, Munich, Germany, |
| | February 2002. Translates queries syntax to fit XML streaming processing |
| 4 | Constructs two hierarchy levels of XML symbols |
| 5 | Basic algorithm of the present invention |
| 6 | Unites different DFAs according to similarities between DFAs symbols |
| 7 | Averbuch et al. ‘307 - “XML Parser” |
| 8 | Averbuch et al. ‘307 - “XML Parser” |
| 9 | “Rete” type matching. C. Forgy, “Rete: A Fast Algorithm for the Many |
| | Pattern/Many Object Pattern Match Problem”, Artificial Intelligence, vol. 19, pp |
| | 17–37, 1982 |

### Uniting of Queries in the Extended Algorithm

Streaming dictates the need to process concurrently a large number of XPath-queries. Therefore, the basic algorithm is extended to fit steaming requirements. This extension is achieved by the module that unites similar DFA_{query} s to be processed together. The input for the unite operation (denoted by 6 in FIG. 20) is a DFA_{query} (denoted by f in FIG. 20). Pseudocode for the uniting algorithm is given in Algorithm 3. In this algorithm, the new DFA_{query} is added to a union of existing DFA_{query}^{C}^{^{k}} which have a “close” alphabet. How is this new DFA_{query} added? The uniting component (denoted by 6 in FIG. 20) creates a new DFA_{query}^{C}^{^{k}} (denoted by n in FIG. 20) that contains the new and the original DFA_{query} s. The new DFA_{query}^{C}^{^{k}} is given as an input to the DFA reduction module (denoted by 5 in FIG. 20).

The following pseudocode (“Algorithm 3”) is pseudocode for the uniting algorithm of module 6 of FIG. 20).

$\begin{matrix}Inputs \text{:} {DFA}_{query} in time t , denoted by {DFA}_{{query}^{t}} = ( {\sum }_{{q}^{t}} , {Q}_{{q}^{t}} , \\ {δ}_{{q}^{t}} , {S}_{{q}^{t}} , {F}_{{q}^{t}} )\end{matrix}$
Output: C^{j}, j = 1, . . . , K
From the processing before time t:
$\begin{matrix}{q}^{t - 1} = {{⋃}^{K}}_{k = 1} {C}^{k} , {C}^{k} = ⋃ {q}^{l} , l \leq t - 1 clusters of {DFA}_{query} before the \\ current time t \\ {DFA}_{query}^{{C}^{k}} = ( {\sum }_{{C}_{k}} , {Q}_{{C}_{k}} , {δ}_{{C}_{k}} , {S}_{{C}_{k}} , {F}_{{C}_{k}} ) , k = 1 , … , K\end{matrix}$
Procedure:
$\begin{matrix}Choose specific j , 1 \leq j \leq K , such that {\sum }_{{C}^{j}} from {DFA}_{query}^{{C}^{j}} \\ is the “ closet ” to {\sum }_{{q}^{t}} from {DFA}_{{query}^{t}}\end{matrix}$
C^{j} ← C^{j}∪DFA_{query′}

End procedure

### Implementation

FIG. 21 is a partial high-level block diagram of a system 100 for implementing the present invention. The major components of system 100 that are illustrated in FIG. 21 are a processor 102, a random access memory (RAM) 104, a non-volatile memory (NVM) 106 such as a hard disk or a flash memory, and a network interface 108. Processor 102, RAM 104, NVM 106 and network interface 108 communicate with each other via a common bus 110. Optionally, system 100 also includes input and output devices in addition to network interface 108, for example a compact disk drive, a USB port, a monitor, a keyboard and/or a mouse, that also communicate via bus 110.

NVM 106 has embodied thereon source code for a message broker of the present invention. Specifically, NVM 106 has embodied thereon source code 112 for implementing the basic method of the present invention as illustrated in FIG. 3 or the extended method of the present invention as illustrated in FIG. 20. The source code is coded in a suitable high-level language. Selecting a suitable high-level language is easily done by one ordinarily skilled in the art. The language selected should be compatible with the hardware of system 100, including processor 102, and with the operating system of system 100. Examples of suitable languages include but are not limited to compiled languages such as FORTRAN, C and C++, and non-compiled languages such as JAVA. NVM 106 is an example of a computer readable storage medium on which is embodied program code of the present invention.

If source code 112 must be compiled to produce executable machine code, processor 102 compiles source code 112 to produce corresponding executable machine code 114 that is stored in RAM 104. If source code 112 does not need to be compiled in order to be executed, source code 112 is copied from NVM 106 to RAM 104 for execution. System 100 is coupled to a network (not shown) by network interface 108. The network could be as small as a two-computer LAN or as large as the worldwide Internet. System 100 could function on the network as a client, a server, a router, a switch, a hub or a gateway. The client may be a portable device such as a smart card, a cellular telephone or a palm pilot. The client may be a RFID tag reader. The server may be a database server for answering queries from clients about XML data in a database; the database itself may be either native or RDBMS or ORDBMS (Object Relational DBMS) or OODBMS (object oriented DBMS). The gateway may function as a XML proxy. XML data to be queried, and optionally the associated schema (“optionally” because source code 112 includes source code for constructing the schema from the data), are received from the network via network interface 108. Processor 102 executes machine code 114 to query the XML data.

Alternatively, rather than store source code for a message broker of the present invention in NVM 106, system 100 downloads executable code from a different node on the network, via network interface 108.

If system 100 is used to query a database then typically the database is stored in NVM 112.

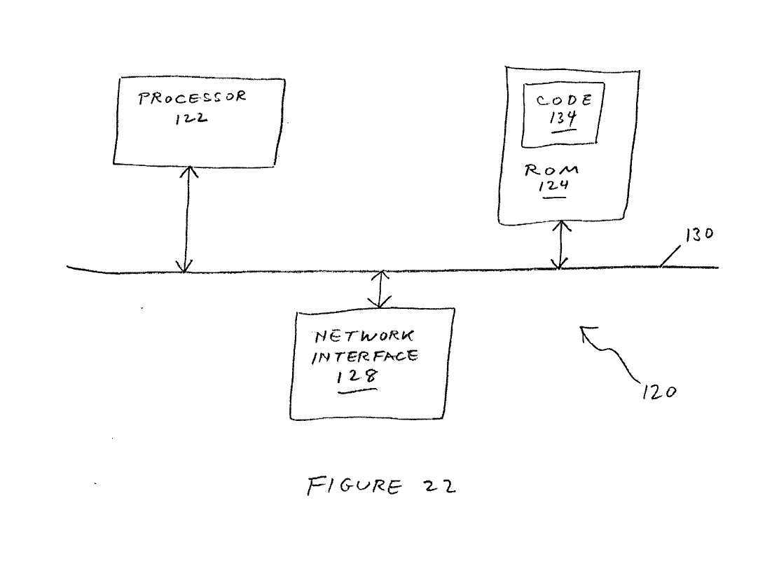

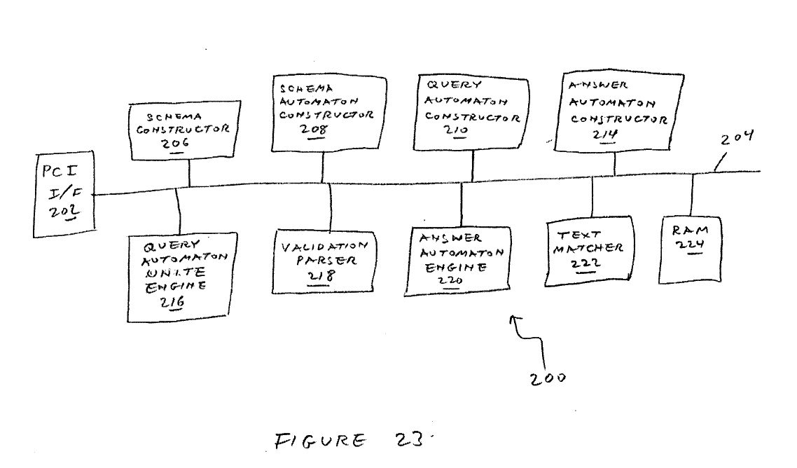

FIG. 22 is a partial high-level block diagram of another system 120 for implementing the present invention. The major components of system 120 that are illustrated in FIG. 22 are a processor 122, a read-only memory (ROM) 124 and a network interface 108. Processor 122, ROM 124 and network interface 128 communicate with each other via a common bus 130.

ROM 124 has embodied thereon executable machine code for a message broker of the present invention. Specifically, ROM 124 has embodied thereon machine code 134 for implementing the basic method of the present invention as illustrated in FIG. 3 or the extended method of the present invention as illustrated in FIG. 20.

System 120 is coupled to a network (not shown) by network interface 128. As in the case of system 100, the network could be as small as a two-computer LAN or as large as the worldwide Internet; and system 120 could function on the network as a client, a server, a router, a switch, a hub, or a gateway, as discussed above in the context of system 100. XML data to be queried, and optionally the associated schema, are received from the network via network interface 128. Processor 122 executes machine code 134 to query the XML data.

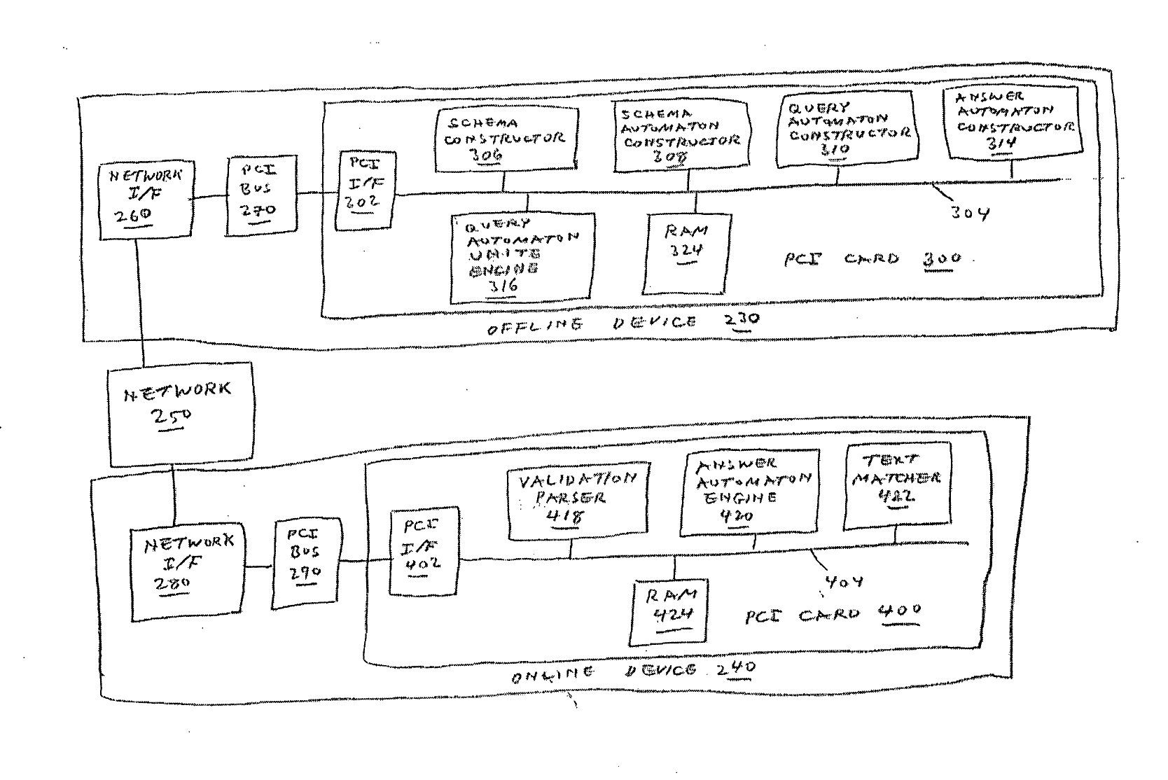

FIG. 23 is a partial high-level block diagram of a hardware implementation of the present invention, specifically a PCI card 200. The major components of PCI card 200 that are illustrated in FIG. 23 are a standard 47-pin PCI interface 202, eight dedicated processors 206, 208, 210, 214, 216, 218, 220 and 222, and a RAM 224, all communicating with each other via a local bus 204. Dedicated processors 206, 208, 210, 214, 216, 218, 220 and 222 are, for example, application-specific integrated circuits (ASICs) or field programmable gate arrays (FPGAs). Dedicated processor 206 is a schema constructor that implements the XML statistics gathering of block (4) of FIG. 20 and the schema building of block (1) of FIG. 20. Dedicated processor 208 is a schema automaton constructor that implements the DFA_{Schema} construction and the XML parser generation of block (2) of FIG. 20. Dedicated processor 210 is a query automaton constructor that implements the DFA_{query} construction of block (3) of FIG. 20. Dedicated processor 214 is an answer automaton constructor that implements the automaton reduction of block (5) of FIG. 20. Dedicated processor 216 is a query automaton unite engine that implements the query uniting of block (6) of FIG. 20. Dedicated processor 218 is a parser that implements the data validation of block (7) of FIG. 20. Dedicated processor 220 is an answer automaton engine that implements the query processing of block (8) of FIG. 20. Dedicated processor 222 is a text matcher that implements the text matching of block (9) of FIG. 20.

Plugging PCI card 200 into the PCI bus of a standard personal computer provides that personal computer with a fast, hardware-based implementation of the functionality of the present invention. Those skilled in the art will readily conceive of analogous hardware implementations of the present invention that are suitable for incorporation in, for example, any of the network devices discussed above in the context of system 100.

FIG. 24 is a partial high-level block diagram of another hardware implementation of the present invention, in which the functionality of the present invention is distributed between two devices, an offline device 230 and an online device 240, that communicate with each other via a network 250. Only the components of devices 230 and 240 that are germane to the present invention are shown in FIG. 24. Those skilled in the art will readily understand what other components need to be included in devices 230 and 240 to render devices 230 and 240 fully functional.

Device 230 includes a PCI card 300 that in turn includes a standard 47-pin PCI interface 302, five dedicated processors 306, 308, 310, 314 and 316, and a RAM 324, all communicating with each other via a local bus 304. Dedicated processors 306, 308, 310, 314 and 316 are, for example, ASICs or FPGAs. Dedicated processor 306 is a schema constructor that implements the XML statistics gathering of block (4) of FIG. 20 and the schema building of block (1) of FIG. 20. Dedicated processor 308 is a schema automaton constructor that implements the DFA_{Schema} construction and the XML parser generation of block (2) of FIG. 20. Dedicated processor 310 is a query automaton constructor that implements the DFA_{query} construction of block (3) of FIG. 20. Dedicated processor 314 is an answer automaton constructor that implements the automaton reduction of block (5) of FIG. 20. Dedicated processor 316 is a query automaton unite engine that implements the query uniting of block (6) of FIG. 20. Device 230 also includes a network interface 260 for communicating with network 250 and a PCI bus 270 to which both network interface 260 and PCI card 300 are operationally connected.

Device 240 includes a PCI card 400 that in turn includes a standard 47-pin PCI interface 402, three dedicated processors 418, 420 and 422, and a RAM 424, all communicating with each other via a local bus 404. Dedicated processors 418, 420 and 422 are, for example, ASICs or FPGAs. Dedicated processor 418 is a parser that implements the data validation of block (7) of FIG. 20. Dedicated processor 420 is an answer automaton engine that implements the query processing of block (8) of FIG. 20. Dedicated processor 422 is a text matcher that implements the text matching of block (9) of FIG. 20. Device 240 also includes a network interface 280 for communicating with network 250 and a PCI bus 290 to which both network interface 280 and PCI card 400 are operationally connected.

Those skilled in the art will readily conceive of analogous distributed hardware implementations of the present invention that distribute the functionality of the present invention among two or more of any of the network devices discussed above in the context of system 100.

As noted at the beginning of this disclosure, the present invention is primarily intended for the fast querying of an XML data stream. The present invention also is eminently suited to similar applications such as fast querying of non-streaming semistructured data such as a fixed XML database.

While the invention has been described with respect to a limited number of embodiments, it will be appreciated that many variations, modifications and other applications of the invention may be made.

What is claimed is:

1. A method of answering a query of semistructured data, comprising the steps of:
(a) constructing an answer automaton, based at least in part on the query and on a schema of the data; and
(b) applying said answer automaton to the data to answer the query.

2. The method of claim 1, wherein said constructing is effected by steps including:
(i) constructing a schema automaton for said schema;
(ii) constructing a query automaton for the query; and
(iii) merging said schema automaton and said query automaton to provide said answer automaton.

3. The method of claim 2, wherein said merging is effected by forming an intersection of said schema automaton and said query automaton.

4. The method of claim 2, wherein said automata are deterministic finite automata.

5. The method of claim 4, wherein said automata are isostate automata.

6. The method of claim 5, wherein said schema automaton first is constructed as a finite automaton that accepts an alphabet and then said alphabet is mapped into a set of transition indices that accept said alphabet, thereby transforming said finite automaton into an isostate automaton.

7. The method of claim 1, wherein said answer automaton is a deterministic finite automaton.

8. The method of claim 7, wherein said answer automaton is a isostate automaton.

9. The method of claim 1, further comprising the step of:
(c) building said schema from the data.

10. The method of claim 1, wherein said applying includes parsing the data, using said answer automaton, to provide a matched context.

11. The method of claim 10, wherein said applying also includes calculating a Boolean expression, that is included in the query, on a textual value of said matched context.

12. The method of claim 10, wherein said constructing is effected by steps including constructing a schema automaton for said schema, using a parser generator that also produces parser tables corresponding to the schema, and wherein said parsing of the data includes using said parser tables to parse the data, thereby producing parser symbols, followed by parsing said parser symbols, using said answer automaton.

13. The method of claim 1, wherein said constructing includes removing redundant symbols from said answer automaton.

14. The method of claim 1, further comprising the steps of:
(c) constructing a parsing table for the data, based on said schema; and
(d) validating the data, prior to said applying, using said parsing table.

15. A method of answering a plurality of queries of semistructured data, comprising the steps of:
(a) constructing an answer automaton, based at least in part on the queries and on a schema of the data; and
(b) applying said answer automaton to the data to answer the queries.

16. The method of claim 15, wherein said constructing is effected by steps including:
(i) constructing a schema automaton for said schema;
(ii) constructing a joint query automaton for the queries; and
(iii) merging said schema automaton and said joint query automaton to provide said answer automaton.

17. The method of claim 16, wherein said constructing of said joint query automaton is effected by steps including:
(A) for each query, constructing a respective query automaton; and
(B) uniting said query automata to provide said joint query automaton.

18. A device for processing semistructured data, comprising:
(a) a memory for storing executable code for answering at least one query of the data, said executable code including:
(i) executable code for constructing an answer automaton, based at least in part on said at least one query and on a schema of the data, and
(ii) executable code for applying said answer automaton to the data to answer said at least one query; and
(b) a processor for executing said executable code.

19. The device of claim 18, further comprising:
(c) a network interface for receiving the data from a network.

20. A computer-readable storage medium having computer-readable code embodied on said computer-readable storage medium, the computer-readable code for answering at least one query of semistructured data, the computer-readable code comprising:
(a) program code for constructing an answer automaton based at least in part on a schema of the data and on the at least one query; and
(b) program code for applying said answer automaton to the data to answer said at least one query.

21. A system for answering a query of semistructured data, comprising:
(a) a schema automaton constructor for constructing a schema automaton for a schema of the data;
(b) a query automaton constructor for constructing a query automaton for the query;
(c) an answer automaton constructor for merging said schema automaton and said query automaton to provide an answer automaton; and
(d) an answer automaton engine for applying the answer automaton to the data to answer the query.

22. The system of claim 21, further comprising:
(e) a schema constructor for constructing said schema from the data.

23. The system of claim 21, wherein said schema automaton constructor includes a parser generator for generating at least one parse table for the data, the system further comprising:
(e) a parser for using said at least one parse table to validate the data.

24. The system of claim 21, wherein said answer automaton parses the data to provide a matched context, the system further comprising:
(e) a text matcher for calculating a Boolean expression, that is included in the query, on a textual value of said matched context.

25. The system of claim 21, wherein said schema automaton constructor, said query automaton constructor, said answer automaton constructor and said answer automaton engine are implemented in a single common device.

26. The system of claim 21, wherein said schema automaton constructor, said query automaton constructor, said answer automaton constructor and said answer automaton engine are implemented in respective members of a plurality of devices that are operationally coupled by a network.

27. An apparatus for answering a plurality of queries of semistructured data, comprising:
(a) a schema automaton constructor for constructing a schema automaton for a schema of the data;
(b) a query automaton constructor for constructing respective query automata for the queries;
(c) a query automaton unite engine for uniting said query automata to provide a joint query automaton;
(d) an answer automaton constructor for merging said schema automaton and said joint query automaton to provide an answer automaton; and
(e) an answer automaton engine for applying the answer automaton to the data to answer the queries.

28. The apparatus of claim 27, wherein said schema automaton constructor, said query automaton constructor, said query automaton unite engine, said answer automaton constructor and said answer automaton engine are implemented in a single common device.

29. The apparatus of claim 27, wherein said schema automaton constructor, said query automaton constructor, said query automaton unite engine, said answer automaton constructor and said answer automaton engine are implemented in respective members of a plurality of devices that are operationally coupled by a network.

30. A method of answering a query of semistructured data, comprising the steps of:
(a) constructing an answer automaton, based at least in part on the query, said constructing including removing redundant symbols from said answer automaton; and
(b) applying said answer automaton to the data to answer the query.

31. A device for processing semistructured data, comprising:
(a) a memory for storing executable code for answering a query of the data, said executable code including:
(i) executable code for constructing an answer automaton, based at least in part on said query, said constructing including removing redundant symbols from said answer automaton, and
(ii) executable code for applying said answer automaton to the data to answer said query; and
(b) a processor for executing said executable code.

32. The device of claim 31, further comprising:
(c) a network interface for receiving the data from a network.

33. A computer-readable storage medium having computer-readable code embodied on said computer-readable storage medium, the computer-readable code for answering a query of semistructured data, the computer-readable code comprising:
(a) program code for constructing an answer automaton, based at least in part on the query, said constructing including removing redundant symbols from said answer automaton; and
(b) program code for applying said answer automaton to the data to answer the query.

34. A system for answering a query of semistructured data, comprising:
(a) an answer automaton constructor for constructing an answer automaton, based at least in part on the query, said constructing including removing redundant symbols from said answer automaton; and
(b) an answer automaton engine for applying said answer automaton to the data to answer the query.

35. A method of answering a query of semistructured data, comprising the steps of:
(a) constructing, for the query, a finite query automaton that accepts an alphabet;
(b) mapping said alphabet into a set of transition indices of said finite query automaton, thereby transforming said finite query automaton into an isostate query automaton;
(c) transforming said isostate query automaton into an answer automaton; and
(d) applying said answer automaton to the data to answer the query.

36. A device for processing semistructured data, comprising:
(a) a memory for storing executable code for answering a query of the data, said executable code including:
(i) executable code for constructing, for said query, a finite query automaton that accepts an alphabet,
(ii) executable code for mapping said alphabet into a set of transition indices of said finite query automaton, thereby transforming said finite query automaton into an isostate query automaton,
(iii) executable code for transforming said isostate query automaton into an answer automaton, and
(iv) executable code for applying said answer automaton to the data to answer said query; and
(b) a processor for executing said executable code.

37. The device of claim 36, further comprising:
(c) a network interface for receiving the data from a network.

38. A computer-readable storage medium having computer-readable code embodied on said computer-readable storage medium, the computer-readable code for answering a query of semistructured data, the computer-readable code comprising:
(a) program code for constructing, for the query, a finite query automaton that accepts an alphabet;
(b) program code for mapping said alphabet into a set of transition indices of said finite query automaton, thereby transforming said finite query automaton into an isostate query automaton;
(c) program code for transforming said isostate query automaton into an answer automaton; and
(d) program code for applying said answer automaton to the data to answer the query.

39. A system for answering a query of semistructured data, comprising:
(a) a query automaton constructor for:
(i) constructing, for the query, a finite query automaton that accepts an alphabet, and
(ii) mapping said alphabet into a set of transition indices of said finite query automaton, thereby transforming said finite query automaton into an isostate query automaton;
(b) an answer automaton constructor for transforming said isostate query automaton into an answer automaton; and
(c) an answer automaton engine for applying said answer automaton to the data to answer the query.
